(19) United States
(12) Patent Application Publication
(10) Pub. No.: US 2025/0350531 A1
(43) Pub. Date: Nov. 13, 2025

(54) CONVERGENCE OF NETWORK FUNCTIONS FOR MEDIA STREAMING

(71) Applicant: Samsung Electronics Co., Ltd., Suwon-si (KR)

(72) Inventor: Prakash Reddy Kolan, Plano, TX (US)

(21) Appl. No.: 19/189,128

(22) Filed: Apr. 24, 2025

Related U.S. Application Data
(60) Provisional application No. 63/644,120, filed on May 8, 2024.
(60) Provisional application No. 63/666,522, filed on Jul. 1, 2024.

(51) Int. Cl. H04L 41/0816; H04L 41/0833; H04L 41/40

(52) U.S. Cl. CPC H04L 41/0816; H04L 41/0833; H04L 41/40

(57) ABSTRACT

A n apparatus includes a transceiver. The transceiver is configured to receive, from a service provider, a trigger to initiate convergence of network functions across a radio access network (RAN) and a core network (CN). The apparatus also includes a processor operably coupled to the transceiver. The processor is configured to, based on receiving the trigger, instantiate one or more converged network functions that perform combined operations in the CN and the RAN. The combined operations relate to at least one of policy management, session management, or user plane management. The processor is also configured to update one or more network elements with configuration information corresponding to the instantiated converged network functions for processing user session traffic.

### CROSS-REFERENCE TO RELATED APPLICATIONS AND CLAIM OF PRIORITY

This application claims priority under 35 U.S.C. § 119(e) to U.S. Provisional Patent Application No. 63/644,120 filed on May 8, 2024, and Provisional Patent Application No. 63/666,522 filed on Jul. 1, 2024. The above-identified provisional patent applications are hereby incorporated by reference in their entirety.

### TECHNICAL FIELD

This disclosure relates generally to wireless networks. More specifically, this disclosure relates to convergence of network functions for media streaming.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for convergence of network functions for media streaming.

In one embodiment, an apparatus is provided. The apparatus includes a transceiver. The transceiver is configured to receive, from a service provider, a trigger to initiate convergence of network functions across a radio access network (RAN) and a core network (CN). The apparatus also includes a processor operably coupled to the transceiver. The processor is configured to, based on receiving the trigger, instantiate one or more converged network functions that perform combined operations in the CN and the RAN. The combined operations relate to at least one of policy management, session management, or user plane management. The processor is also configured to update one or more network elements with configuration information corresponding to the instantiated converged network functions for processing user session traffic.

In another embodiment, a method of operating an apparatus is provided. The method includes receiving, from a service provider, a trigger to initiate convergence of network functions across a RAN and a CN, and based on receiving the trigger, instantiating one or more converged network functions that perform combined operations in the CN and the RAN. The combined operations relate to at least one of policy management, session management, or user plane management. The method also includes updating one or more network elements with configuration information corresponding to the instantiated converged network functions for processing user session traffic.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4A illustrates an example NG-RAN overall architecture according to embodiments of the present disclosure;

FIG. 4B illustrates an example for gNB-CU-CP and gNB-CU-UP separation according to embodiments of the present disclosure;

FIG. 5 illustrates an example 5GMS architecture according to embodiments of the present disclosure;

FIG. 6 illustrates an example of end-to-end application traffic connectivity according to embodiments of the present disclosure;

FIG. 7 illustrates an example O-RAN logical architecture according to embodiments of the present disclosure;

FIG. 8 illustrates an example policy provisioning in a RAN network from an application provider according to embodiments of the present disclosure;

FIG. 9 illustrates an example of converged policy management according to embodiments of the present disclosure;

FIG. 10 illustrates an example of converged session management according to embodiments of the present disclosure;

FIG. 11 illustrates an example of converged user plane management according to embodiments of the present disclosure;

FIG. 12 illustrates an example of end-to-end connectivity using converged RAN and core network functions according to embodiments of the present disclosure;

FIG. 13 illustrates an example of application enabled end-to-end connectivity according to embodiments of the present disclosure;

FIG. 14 illustrates an example procedure for RAN and CN network convergence according to embodiments of the present disclosure;

FIG. 15 illustrates examples of intra-PLMN and inter-PLMN scenarios for using multiple access networks according to embodiments of the present disclosure;

FIG. 16 illustrates an example dual steering architecture according to embodiments of the present disclosure;

FIGS. 17A-17C illustrate an example procedure for background data transfer session configuration and establishment according to embodiments of the present disclosure;

FIG. 18 illustrates an example of UEs with different capabilities for simultaneous transmission over multiple access networks according to embodiments of the present disclosure;

FIG. 19 illustrates an example procedure to allow a temporary upgrade in policy treatment for application flows of a UE with no capabilities to use multiple access networks simultaneously according to embodiments of the present disclosure;

FIG. 20 illustrates an example procedure to instantiate edge application services to aid UEs with no or limited capabilities to use multiple access networks simultaneously according to embodiments of the present disclosure;

FIG. 21 illustrates an example procedure based on network slicing to aid UEs with no or limited capabilities to use multiple access networks simultaneously according to embodiments of the present disclosure;

FIG. 22 illustrates an example procedure based on traffic burst to aid UEs with no or limited capabilities to use multiple access networks simultaneously according to embodiments of the present disclosure;

FIG. 23 illustrates an example procedure based on data transfer opportunities to aid UEs with no or limited capabilities to use multiple access networks simultaneously according to embodiments of the present disclosure; and

FIG. 24 illustrates an example method for convergence of network functions for media streaming according to embodiments of the present disclosure.

### DETAILED DESCRIPTION

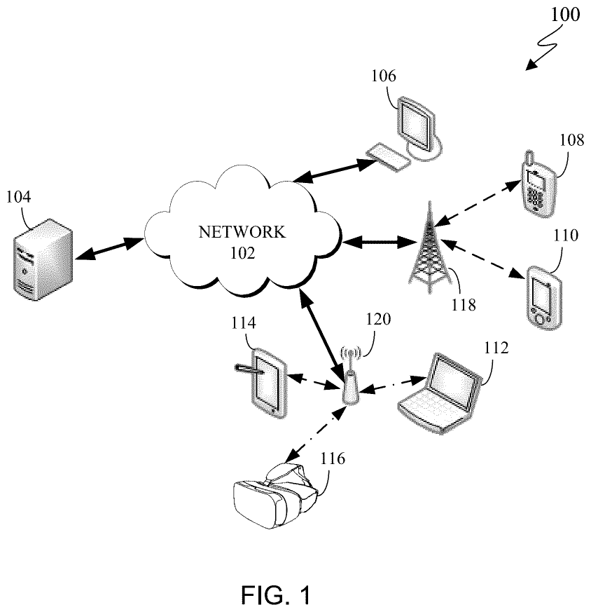

FIGS. 1 through 24, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

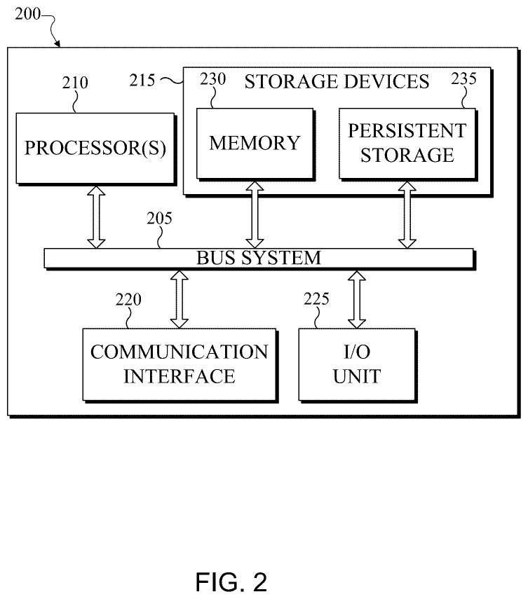

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Next generation services with complex application requirements are being planned for deployment in communications systems such as 5G and 6G networks. However, the network architecture for 5G and 6G networks is still based on a methodology of network functions with strict deployment options. Furthermore, data centers are being deployed at a rapid pace, and the infrastructure management costs in these data centers is high. Many data centers report high usage of power and energy to keep these network functions up and running. New techniques for managing network functions are desirable to address growing demands from next generation services.

Existing 5G networks are limited in terms of their capabilities to support some complex applications and services that are technically feasible for deployment. For example, services with ultra-low latency and ultra-high throughput requirements may not be adequately provisioned because of an inability of existing 5G networks to support the ultra-low latency and ultra-high throughput requirements. One reason existing 5G networks may be unable to support the ultra-low latency and ultra-high throughput requirements is due to a high number of network functions that are used to process the control and user plane traffic of application sessions. Another reason may be high energy consumption of these network functions. To facilitate deployment and provisioning of complex applications and services, various embodiments of the present disclosure provide methods and apparatus for converging similar network functions of radio access networks (RANs) and core networks (CNs) to minimize infrastructure level complexities.

With higher bandwidth and throughput 5G networks, application server providers are designing and developing applications that were infeasible with 4G LTE networks. In addition, device vendors are adding more capabilities to end user devices, for example allowing multiple access technologies (e.g., 5G, LTE, Wi-Fi, Satellite access etc.). Service providers are developing applications and services that UE devices may use using one or more of the above access technologies, sometimes using two or more of them at the same time. It is desirable to develop methods so devices of varied capabilities can access those applications and services.

Some or most of 4G LTE and 5G UEs have capabilities to access applications/services with one or more access technologies. Service providers provide connectivity information, and these devices use one or more of the access network endpoints to connect to those applications/services using the connectivity information. However, there are still a number of UE devices that have at most one access technology for data transmission/reception (e.g., low power UE sensor devices, receive only devices etc.). There are also devices that may not use multiple access technologies simultaneously because of security reasons. These UEs have no, or limited, capabilities to transmit/receive over multiple access networks simultaneously. The present disclosure provides apparatuses and methods to aid the above type of UEs so that the UEs obtain a similar performance/experience of UEs with higher capabilities to use multiple access networks simultaneously.

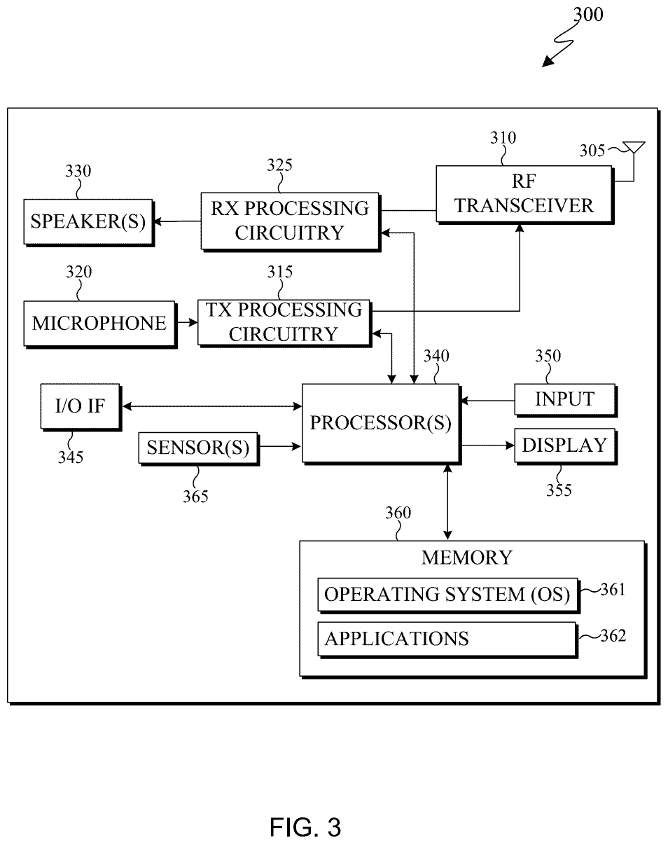

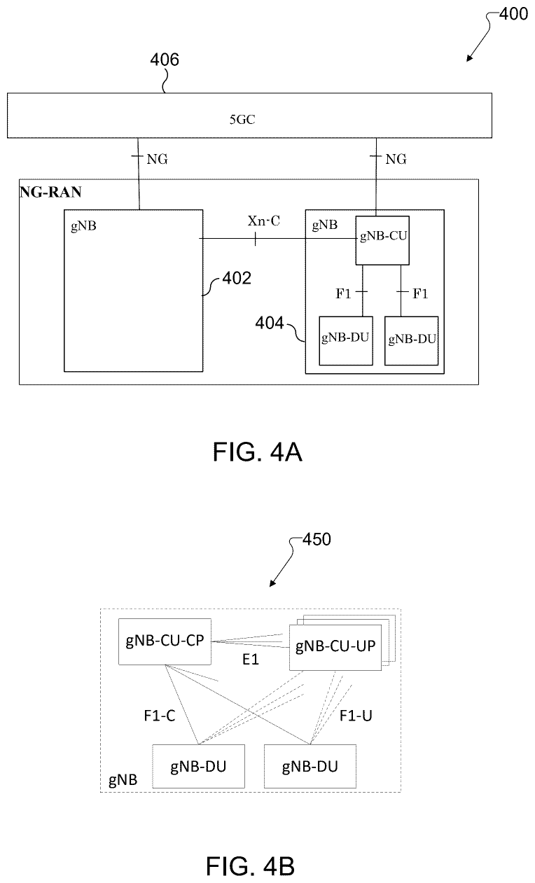

The 3^{rd} Generation Partnership project (3GPP) RAN standardization body has specified the next generation radio access network (NG-RAN) architecture shown in FIGS. 4A and 4B for different components in a 5G radio access network.

FIG. 4A illustrates an example NG-RAN overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. 5GC 406 may include one or more access and mobility management functions (AMFs), user plane functions (UPFs), session management functions (SMFs), policy control functions (PCFs), etc. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

Different components of the NG-RAN architecture facilitate connectivity to core network (CN) components for mobile devices so applications on the mobile devices are able to reach the data network the mobile devices intend to reach for accessing those applications.

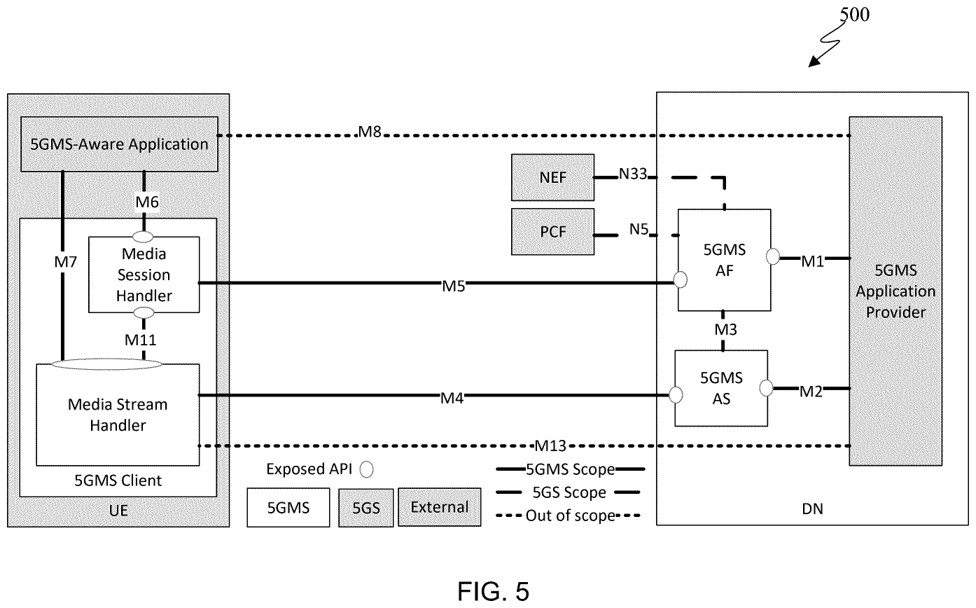

The 3GPP technical specification group (TSG) and system aspects (SA) working group 4 (WG4) is standardizing media services for deployment in 5G networks. The NG-RAN architecture of FIGS. 4A and 4B can be extended into the end-to-end architecture shown in FIG. 5, which shows a reference architecture developed by 3GPP TSG SA WG4 for 5G Media Streaming (5GMS).

FIG. 5 illustrates an example 5GMS architecture 500 according to embodiments of the present disclosure. The embodiment of a 5GMS architecture of FIG. 5 is for illustration only. Different embodiments of a 5GMS architecture could be used without departing from the scope of this disclosure.

5GMS architecture 500 includes the following components:
5GMSd AF: An Application Function in the 5G core network that performs signaling functions of the application service.
5GMSd AS: An Application Function in the 5G core network that performs media functions (e.g., media processing) for the application server.
5GMSd Aware Application: An application in the UE (e.g., a user app) that receives application service information from an external 5GMSd Application Provider. The application service information is then used for retrieving information and data related to that application from the 5G core network.
Media Session Handler: A component of the UE that enables communication with a signaling Application Function in the 5G core network for setting up the relevant media channels between the UE and the 5G core network.
Media Player: A component of the UE that receives media data from the media application function in the 5G core network and provides the data to the 5GMSd Aware Application, and vice versa.

In the 5GMS architecture 500, 5G media streaming is enabled by setting up a couple of application functions—one that performs signaling functions and another that performs media functions. There can be multiple instances of these application functions depending upon application requirements. Different components of the UE connect to these application functions to exchange signaling and media data to avail the 5G media streaming service offered by the mobile operator.

Although FIG. 5 illustrates an example NG-RAN overall architecture 500, various changes may be made to FIG. 5. For example, architecture 500 could include additional core network functions, etc. according to particular needs.

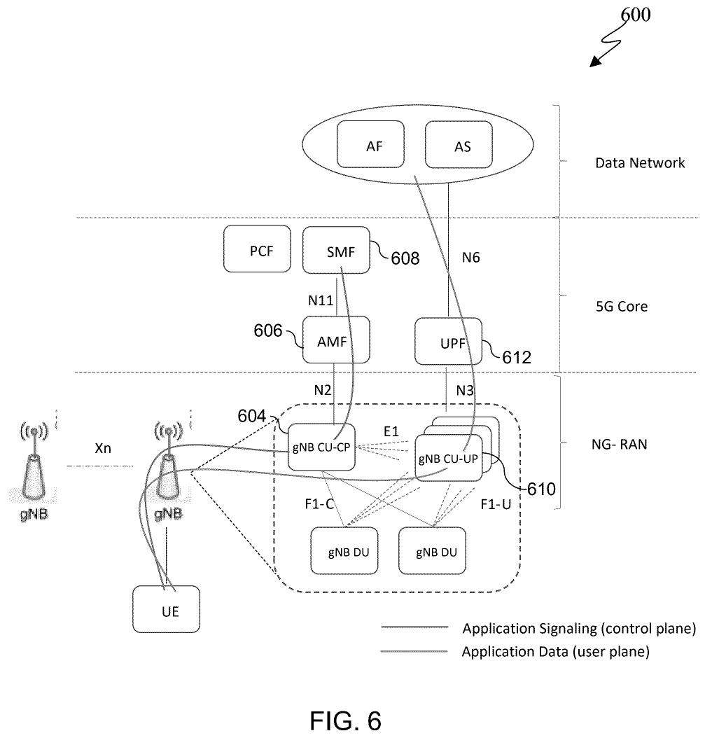

The end-to-end application connectivity architecture when running the 5G Media Streaming Application traffic shown in FIG. 5 over the connectivity architecture shown in FIG. 4 can be seen in FIG. 6.

FIG. 6 illustrates an example 600 of end-to-end application traffic connectivity according to embodiments of the present disclosure. The embodiment of end-to-end application traffic connectivity of FIG. 6 is for illustration only. Different embodiments of end-to-end application traffic connectivity could be used without departing from the scope of this disclosure.

In example 600 of FIG. 6, control plane traffic related to a 5G media streaming application is transported through a gNB (CU-CP) 604, AMF 606, SMF 608, etc., while user plane traffic related to the 5G media streaming application is transported through the gNB (CU-UP) 610 and UPF 612.

Although FIG. 6 illustrates one example 600 of end-to-end application traffic connectivity, various changes may be made to FIG. 6. For example, example 600 could include additional core network functions, additional routes, etc. according to particular needs.

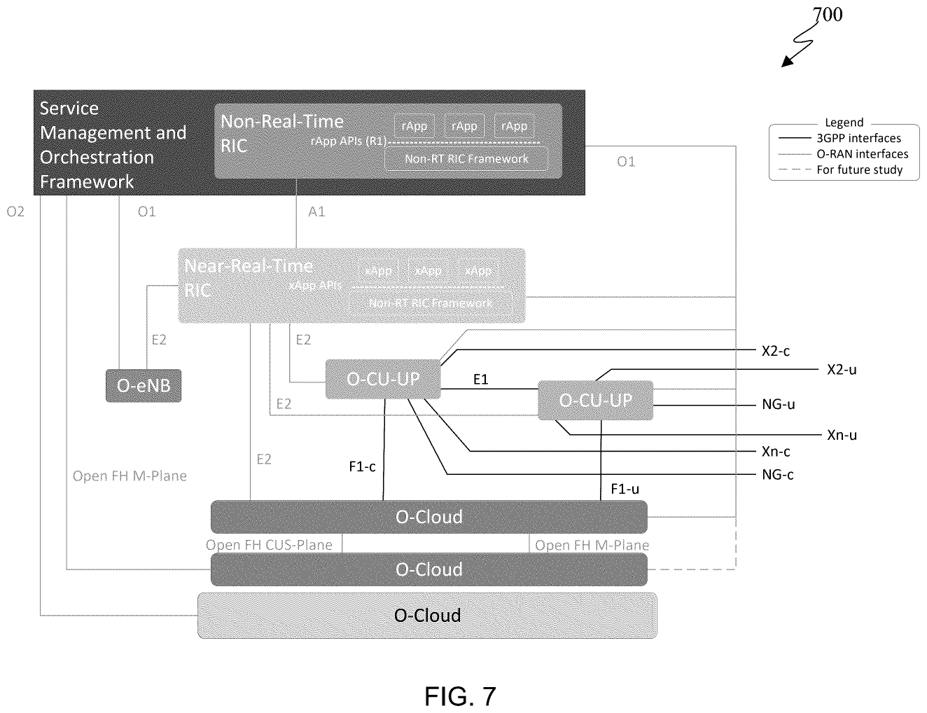

O-RAN Alliance is a standards body that specifies architecture for open and intelligent Radio Access Networks. FIG. 7 shows a logical open RAN (O-RAN) architecture in accordance with O-RAN Alliance specifications.

FIG. 7 illustrates an example O-RAN logical architecture 700 according to embodiments of the present disclosure. The embodiment of an O-RAN logical architecture of FIG. 7 is for illustration only. Different embodiments of an O-RAN logical architecture could be used without departing from the scope of this disclosure.

In the example of FIG. 7, O-RAN logical architecture 700 includes a Service Management and Orchestration (SMO) Framework that facilitates general application deployment and deployment through which some generated policies can be provisioned into RAN devices over an A1 interface. The provisioned policies then become the basis of operation for O-CU-CP and O-CU-UP devices. These devices interact with O-DU and O-RU devices to implement the specified policies from the SMO layer.

Although FIG. 7 illustrates an example O-RAN logical architecture 700, various changes may be made to FIG. 7. For example, architecture 700 could include additional devices, interfaces, etc. according to particular needs.

There are components in a RAN network that take responsibility of policy management aspects of user sessions. For example, in a 5G RAN network, the gNB CU-CP function takes the responsibility of receiving policy information or configuration from core network entities (e.g., PCF and SMF via AMF), and enforcing the policy by communicating with the gNB CU-UP entity. The traffic flowing through the gNB CU-UP entity is then enforced using the policy information received from the network (i.e., the core network), or through a request from a UE. Similarly, on the core network side, the PCF is the primary network function responsible for central policy management.

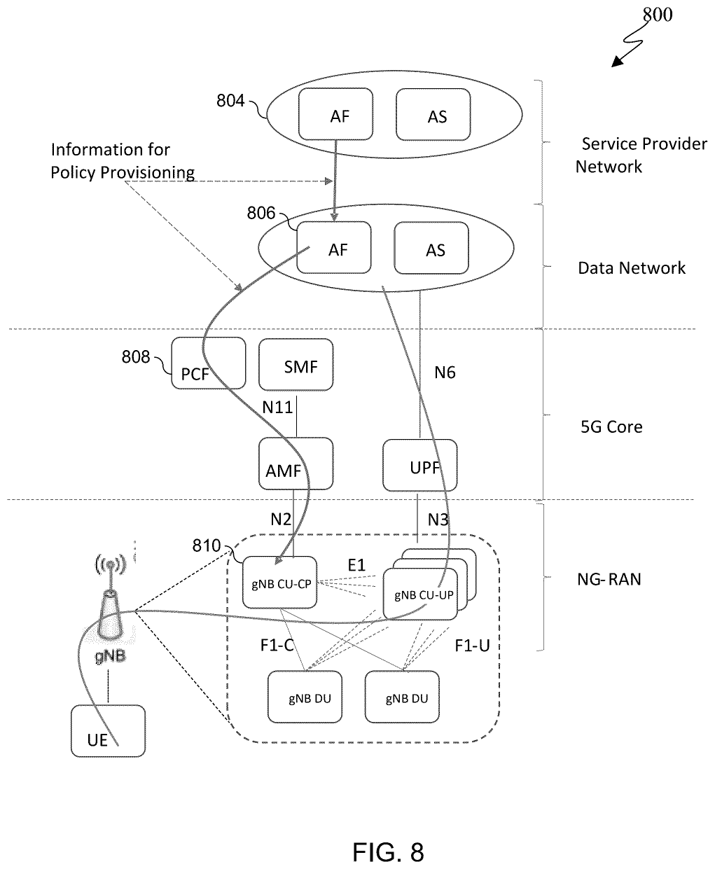

FIG. 8 illustrates an example policy provisioning 800 in a RAN network from an application provider according to embodiments of the present disclosure. The embodiment of policy provisioning of FIG. 8 is for illustration only. Different embodiments of policy provisioning in a RAN network from an application provider could be used without departing from the scope of this disclosure.

In the example of FIG. 8, an external application provider or service provider 804 provides information for policy provisioning to the AF 806 in a 5G network, which then uses various interfaces to communicate with a PCF 808 to apply necessary policies to the traffic of the application provided by the application provider. When PCF 808 gets this information, it interacts with gNB CU-CP 810 to have the respective policy applied to user session traffic belonging to the service provider application.

Although FIG. 8 illustrates an example policy provisioning 800 in a RAN network from an application provider, various changes may be made to FIG. 8. For example, the 5G network could include additional core network functions, etc. according to particular needs.

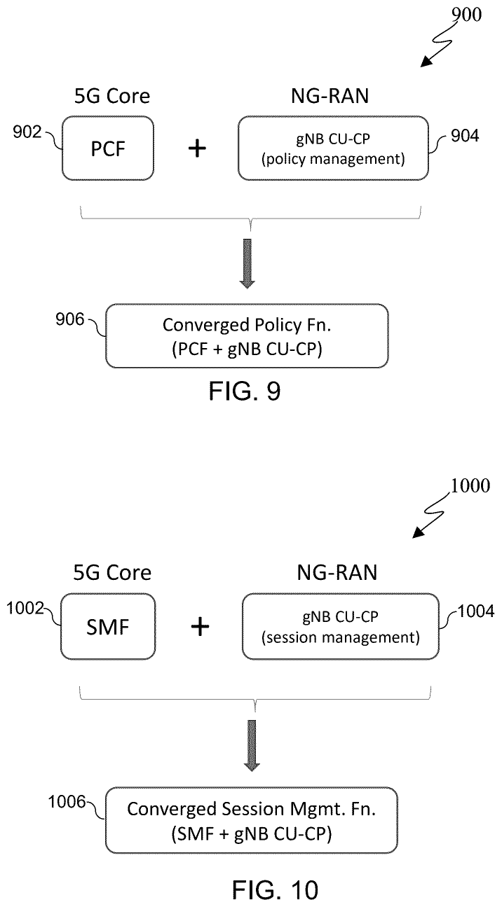

It is possible to merge the functionality of different network functions in different network subnets (e.g., a RAN and a core network) that provide similar functionality to user session traffic. For example, it is feasible to merge the functionalities of a PCF and a gNB CU-CP entity to have one entity for policy management as shown in FIG. 9.

FIG. 9 illustrates an example 900 of converged policy management according to embodiments of the present disclosure. The embodiment of converged policy management of FIG. 9 is for illustration only. Different embodiments of converged policy management could be used without departing from the scope of this disclosure.

In the example 900 of FIG. 9, functionalities of PCF instance 902 of a 5G core are combined with that of gNB CU-CP instance 904 (which performs policy management) of an NG-RAN to form a converged policy function 906.

Although FIG. 9 illustrates an example 900 of converged policy management, various changes may be made to FIG. 9. For example, the converged policy function could include functionalities of other network entities, etc. according to particular needs.

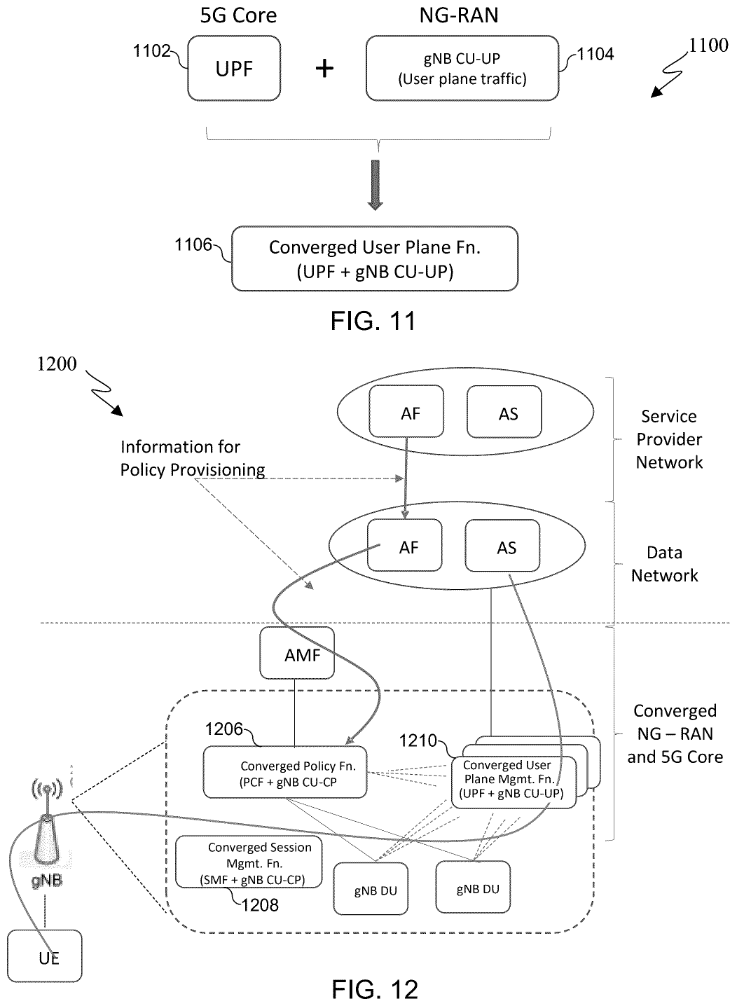

Similar to the embodiment of converged policy management discussed herein, a converged session management function is possible by combining the functionality of the session management functions in a core network and a RAN network. For example, in the core network, session management may be handled by the SMF, while in the RAN, the session management responsibility may be handled by the CU-CP. These two functionalities, can be combined to have one entity for session management as shown in FIG. 10.

FIG. 10 illustrates an example 1000 of converged session management according to embodiments of the present disclosure. The embodiment of converged session management of FIG. 10 is for illustration only. Different embodiments of converged session management could be used without departing from the scope of this disclosure.

In the example 1000 of FIG. 10, functionalities of SMF instance 1002 of a 5G core are combined with functionalities of gNB CU-CP instance 1004 (which performs session management) of an NG-RAN to form a converged session management function 1006.

Although FIG. 10 illustrates an example 1000 of converged session management, various changes may be made to FIG. 10. For example, the converged session management function could include functionalities of other network entities, etc. according to particular needs.

Similar to the embodiments of converged policy management and converged session management discussed herein, a converged user plane management function is possible by combining the functionality of user plane management functions in a core network and a RAN network. In the core network, user plane management is handled by a UPF, while in the RAN, the user plane management is handled by a CU-UP. B These two functionalities, can be combined to have one entity for user plane management as shown in FIG. 1.

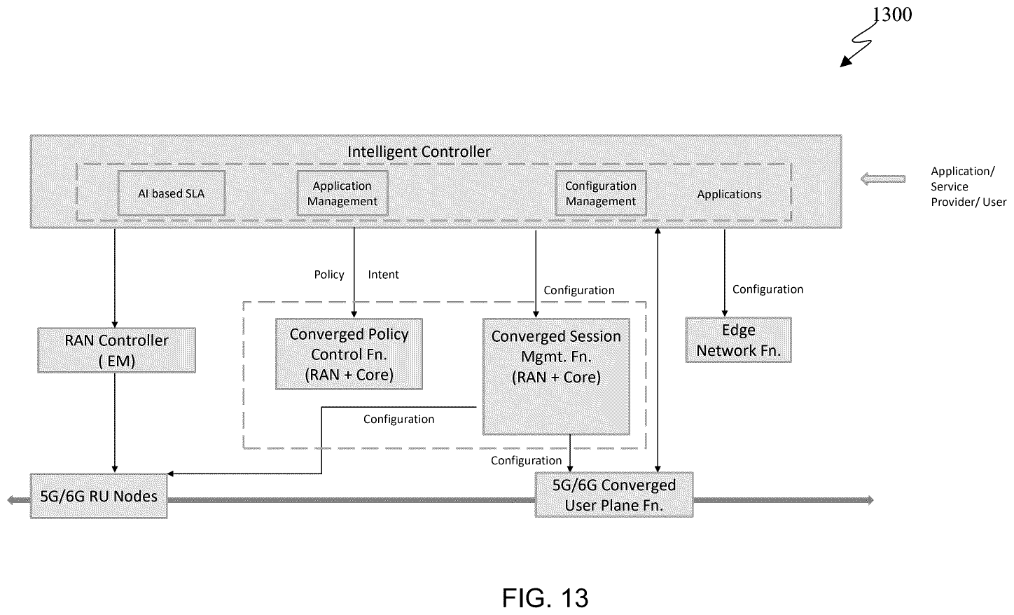

FIG. 11 illustrates an example 1100 of converged user plane management according to embodiments of the present disclosure. The embodiment of converged user plane management of FIG. 11 is for illustration only. Different embodiments of converged user plane management could be used without departing from the scope of this disclosure.

In the example 1100 of FIG. 11, functionalities of UPF instance 1102 of a 5G core are combined with functionalities of gNB CU-UP instance 1104 (which performs user plane management) of an NG-RAN to form a converged user plane management function 1106.

Although FIG. 11 illustrates an example 1100 of converged user plane management, various changes may be made to FIG. 11. For example, the converged user plane function could include functionalities of other network entities, etc. according to particular needs.

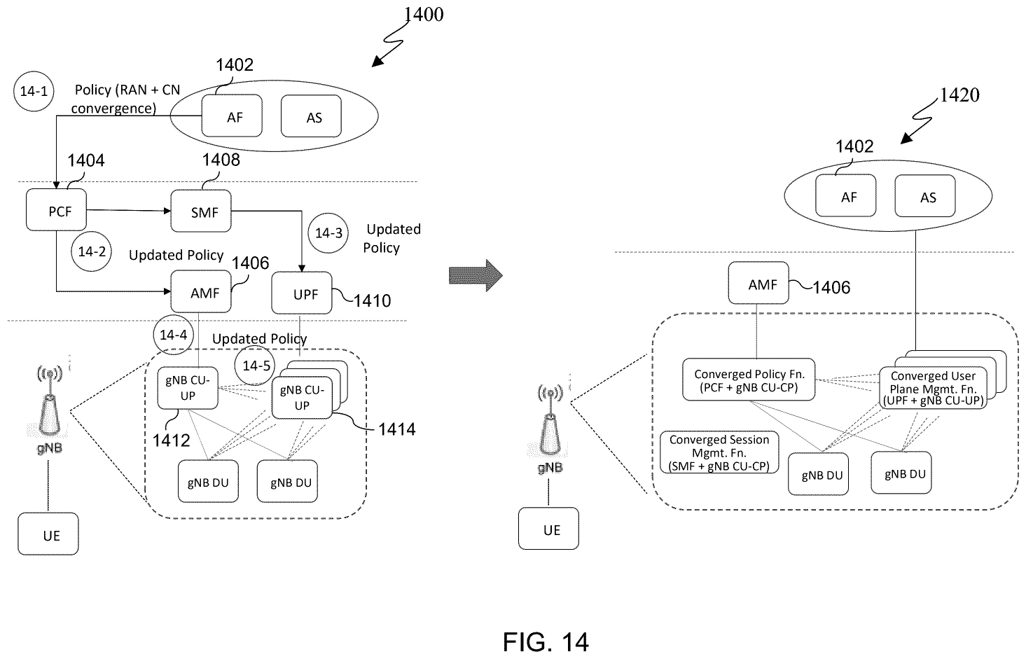

Utilizing the converged policy management, session management, and user plane functions described herein, an end-to-end architecture for user plane connectivity as shown in FIG. 12 can be formed.

FIG. 12 illustrates an example 1200 of end-to-end connectivity using converged RAN and core network functions according to embodiments of the present disclosure. The embodiment of end-to-end connectivity of FIG. 1200 is for illustration only. Different embodiments of end-to-end connectivity using converged RAN and core network functions could be used without departing from the scope of this disclosure.

In example 1200 of FIG. 12, control plane traffic and user plane traffic related to a 5G Media Streaming Application are transported through a converged NG-RAN and 5G core that includes a converged policy function 1206, a converged session management function 1208, and a converged use plane management function 1210.

Although FIG. 12 illustrates one example 1200 of end-to-end connectivity using converged RAN and core network functions, various changes may be made to FIG. 12. For example, 1200 could include additional core network functions, additional routes, etc. according to particular needs.

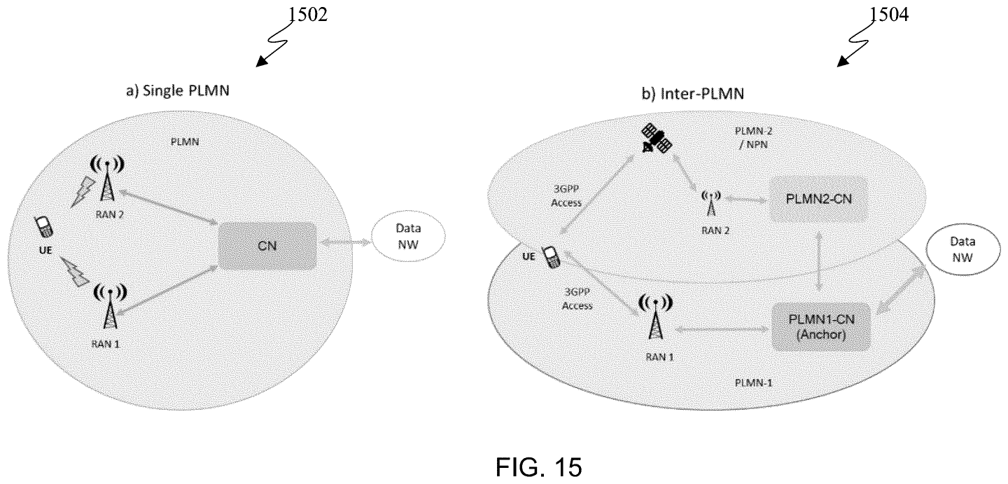

Utilizing the converged RAN and core network functions shown in FIG. 12 and the O-RAN logical architecture shown in FIG. 7, an application enabled architecture for end-to-end connectivity as shown in FIG. 13 can be formed.

FIG. 13 illustrates an example 1300 of application enabled end-to-end connectivity according to embodiments of the present disclosure. The embodiment of application enabled end-to-end connectivity of FIG. 13 is for illustration only. Different embodiments of application enabled end-to-end connectivity could be used without departing from the scope of this disclosure.

In the example 1300 of FIG. 13, an intelligent controller facilitates general application deployment and deployment through which some generated policies can be provisioned into converged RAN and core network instances. The provisioned policies then become the basis of operation for the converged RAN and core network instances. These instances interact with other devices or instances to implement the specified policies from the intelligent controller.

Although FIG. 13 illustrates example 1300 of application enabled end-to-end connectivity, various changes may be made to FIG. 13. For example, example 1300 could include additional converged functions, etc. according to particular needs.

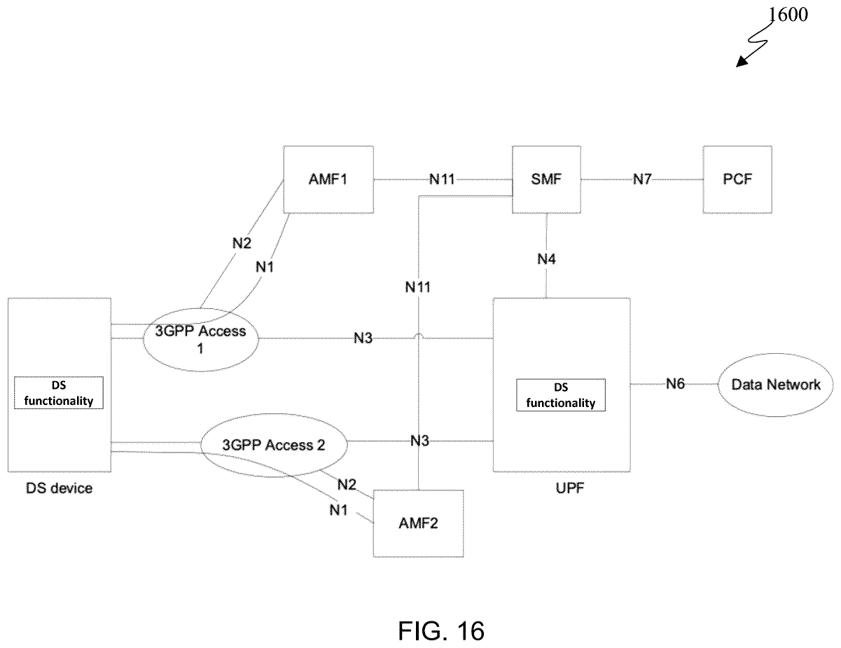

Similar network functions in a RAN and core network can be converged as described herein depending on the need for such a situation. A procedure for network function convergence assuming certain triggers occur is shown in FIG. 14. Various candidate triggers that may necessitate such a convergence of similar network functions in a RAN and core network are later described herein.

FIG. 14 illustrates an example procedure 1400 for RAN and CN network convergence according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for RAN and CN network convergence could be used without departing from the scope of this disclosure.

In the example of FIG. 14, it is assumed that a trigger for network function convergence has occurred.

Procedure 1400 begins at step 14-1. At step 14-1, an application function 1402 in a core network gets notified of the trigger for network function convergence. The application function 1402 then sends an updated policy to the PCF 1404 of the core network about convergence of similar functionality network functions in the core network and radio network.

At step 14-2, the PCF 1404 translates the above policy and updates the policy at other core network functions such as the AMF 1406 and SMF 1408.

At step 14-3, the SMF 1408 updates the configuration of UPF 1410 based on a predetermined procedure. The updated configuration in this case relates to the convergence of RAN and core network user plane functionality required for further processing of user session traffic.

At step 14-4, the AMF conveys to the gNB CU-CP 1412 the updated policy information to trigger convergence of the RAN and core network functions.

At step 14-5 the gNB CU-CP 1412 informs gNB CU-UP 1414 of such convergence. To facilitate the convergence, the gNB CU-CP 1412 instantiates converged policy network functions, session management functions, and user plane functions similar as described herein. The gNB CU-CP 1412 then informs the AMF 1406 of such network functions, and provides all required endpoint information so AMF 1406 may reach the appropriate network functions. The AMF 1406 then associates the control and user plane paths of the application function and application server in the data network with the updated paths pointing to the newly instantiated converged network functions as shown in example 1420.

Although FIG. 14 illustrates one example procedure 1400 for RAN and CN network convergence, various changes may be made to FIG. 14. For example, while shown as a series of steps, various steps in FIG. 14 could overlap, occur in parallel, occur in a different order, occur any number of times, be omitted, or replaced by other steps.

The following are some examples of triggers for a procedure for convergence of similar network functions in a core network and radio network similar as described herein:
Ultra-Low Latency Application Requirements: Traditionally, when an application service provider configures latency requirements, the latency budget is divided between multiple subnets—the core subnet, transport network subnet, and the radio network subnet. The end-to-end latency of a session spanning these subnets ought to be less than the service provider configured latency. It is possible that for ultra-low latency applications, the latency requirements are lower than what can be provided by a traditional 3-subnet session. In this case, when the application service provider provides a policy with ultra-low latency application requirements, the AF in the data network may trigger the convergence of similar network functions in the core network and RAN as described herein. By combining or co-locating the core network and RAN functionality, and thereby eliminating the transport network latency budget requirements, the 3-subnet session essentially becomes a 1-subnet session, allowing an increased latency budget for the subnet with converged network functions.
Ultra-high Throughput Application Requirements: Requirements for ultra-high throughput are typically applied as described above for latency requirements (i.e., the ultra-high throughput is required for each of the subnets on which the user session traffic traverses). Similar to the case of ultra-low latency, if the ultra-high throughput applications may not be accommodated by one or more subnets, the AF may trigger a procedure for convergence of similar network functions in the core network and RAN as described herein. By combining or co-locating the core network and RAN functionality as described herein, and thereby eliminating the transport network requirements, the 3-subnet session essentially becomes a 1-subnet session, thereby allowing ultra-high throughput for the single subnet with converged network functions, which is more likely to be realized than with a 3-subnet session.
Lower energy requirements: Energy costs are increasingly burdensome for network operators while realizing multiple application service requirements across all subnets. To facilitate lower energy consumption, any of the network functions may trigger a procedure for convergence of similar network functions in the core network and RAN as described herein. Additionally, the energy consumption requirements may also be configured as a result of agreements between the network operator and the application service provider in which case the AF may trigger a procedure for convergence of similar network functions in the core network and RAN as described herein. Existing methodologies of measuring energy consumption may be used to analyze energy consumption for different network functions in different subnets, and a procedure for convergence as described herein may be triggered.

The following are some examples of methods to realize convergence of similar network functions in a RAN and core network:
Combining or converging: In some embodiments, the functionality of similar network functions in a RAN and CN domain may be combined and provisioned/deployed as a single network function. Due to network function virtualization (NFV) virtualization software paradigm, it is feasible that the functionality can be combined to produce a single virtual machine or container with the combined functionality. When converged in this manner, the interfaces that exist between these network functions become internal interfaces in the combined entity.
Co-locating: In some embodiments, similar network functions may co-located (i.e., located close to each other). Existing interfaces between the network functions may still remain in this scenario. Traditionally, there are different network function virtualization infrastructure (NFVI) domains for instantiating and running RAN virtual machines/instances and CN virtual machines/instances. In some embodiments RAN and core network functions may be instantiated onto the same NFVI domain, thereby eliminating transport network requirements between the RAN and CN functions. With co-location, management of the network functions is simplified, and therefore orchestration mechanisms become possible.
Relocation: In some embodiments, network functions may be relocated when certain conditions are satisfied. For instance, the conditions may be based on the triggers for convergence described herein. For example, when there are requirements for ultra-low latency or ultra-high throughout sessions, or due to energy savings requirements, existing network functions in different NFVI domains may be relocated to a different set of NFVI domains, or all of the network functions may be relocated and deployed in same NFVI domain, to realize application requirements for ultra-low latency or ultra-high throughout sessions.

As described herein, an application enabled architecture for end-to-end connectivity with converged network functions may be deployed. In some embodiments, an application service provider may provide some information for a mobile network operator (MNO) to facilitate the convergence of the network functions as described herein. For example, the application service provider may provide the MNO (or an Application Function inside the MNO acting as a controller device) a message with some or all of the information elements shown in Table 1.

TABLE 1

| Information Element | Description |
|---|---|
| enable_convergence | Boolean variable to indicate whether the MNO enables |
| | convergence of similar network functionalities in the |
| | RAN and CN network as described herein |
| convergence_method | Type of convergence method to enable among different |
| | methods described herein. Possible values include: |
| | Combine/converge: Instances of similar network |
| | functions are combined to produce a single |
| | separate instance |
| | Co-locate: Similar network functions are co- |
| | located together |
| | Relocate: relocate network functions close to |
| | each other in case the relocation conditions |
| | described in this table meet. |
| relocation_conditions | Conditions to satisfy to initiate the procedure of |
| | relocating similar network functions close to each other. |
| | Conditions could be in the form of service level |
| | agreement (SLA) requirements (e.g., latency <20 msec, |
| | throughput >20 mbps) etc. |
| | The relocation conditions may be in the form of policy |
| | requirements for application session traffic. |

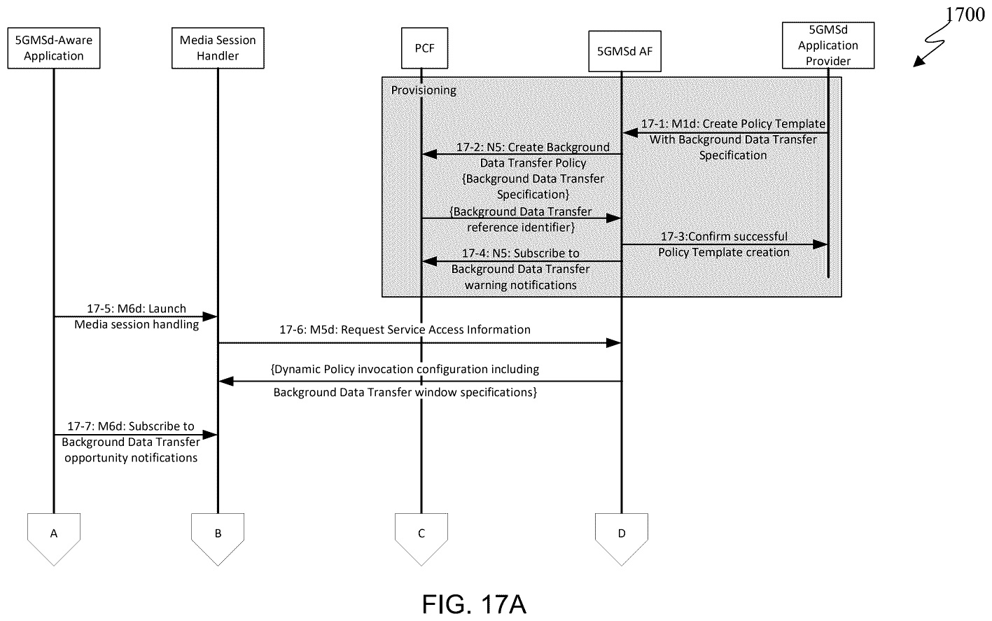

Wireless networks may support a set of use cases and service requirements related to 5G system support of traffic switching, splitting, and steering of a UE's user data across multiple 3GPP access networks. FIG. 15 shows examples of Intra-public land mobile network (PLMN) and Inter-PLMN scenarios for using multiple access networks.

FIG. 15 illustrates examples 1502-1504 of intra-PLMN and inter-PLMN scenarios for using multiple access networks according to embodiments of the present disclosure. The embodiments of intra-PLMN and inter-PLMN scenarios of FIG. 15 are for illustration only. Different embodiments of intra-PLMN and inter-PLMN scenarios for using multiple 3GPP access networks.

In the examples of FIG. 15 the UE is connected to more than one access network at the same time. Traffic from different applications installed on the UE may use one or more access networks to connect to the UE's service endpoints, either inside the operator network, or through the operator network into the external Internet. The type of access networks are not limited to terrestrial mobile networks, but could also be satellite networks, Non-public networks (NPNs) etc. In example 1502, the UE is connected to multiple access networks of the same PLMN, while in example 1504, the UE is connected to access networks of different PLMNs.

Although FIG. 15 illustrates examples 1502-1504 of intra-PLMN and inter-PLMN scenarios for using multiple 3GPP access networks, various changes may be made to FIG. 15. For example, examples 1502-1504 could include additional access networks, different access networks, etc. according to particular needs.

Wireless networks may support operation of a dual steering (DS) device that is capable of traffic steering and switching of user data for different services across two 3GPP access networks as shown in FIG. 5.

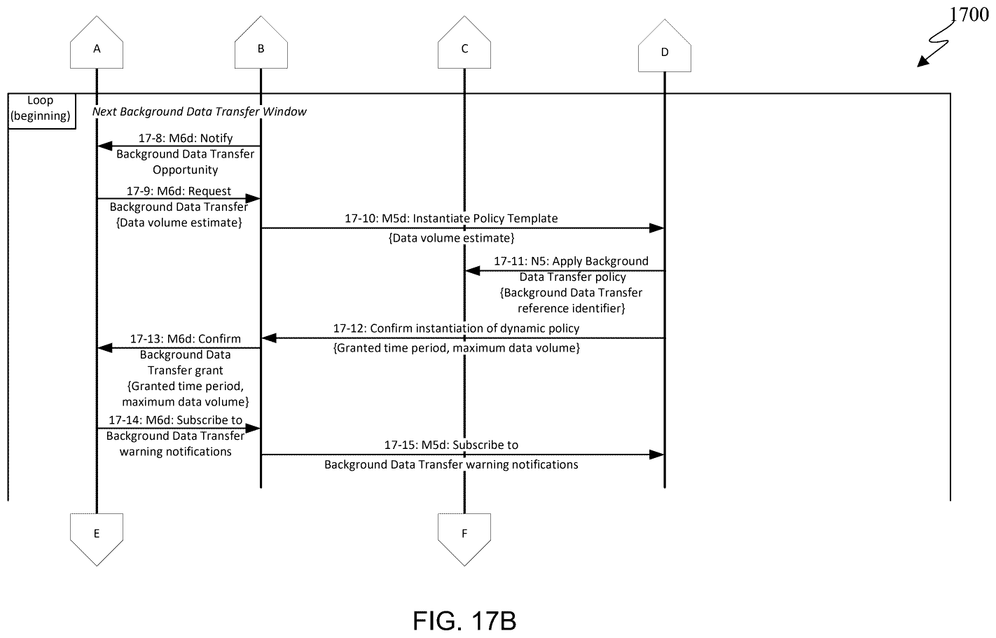

FIG. 16 illustrates an example dual steering architecture 1600 according to embodiments of the present disclosure. The embodiment of a dual steering architecture of FIG. 16 is for illustration only. Different embodiments of a dual steering architecture could be used without departing from the scope of this disclosure.

In the example of FIG. 16, the dual steering functionality (DS functionality) inside the DS device allows connection to the operator network UPF using multiple 3GPP access networks. With the DS functionality, the network may see that the network is interacting with two different 3GPP UE endpoints when in fact it is the same UE that has credentials to access content over multiple access networks. The DS functionality enables separate registration and UE session management over each of the connected 3GPP access networks. With DualSteer and multipath delivery as shown FIG. 16, clients are able to use the capabilities of two or more access networks to connect to application service endpoints (or application servers) through the operator network.

Although FIG. 16 illustrates an example dual steering architecture 1600, various changes may be made to FIG. 16. For example, architecture 1600 could include additional interfaces, routes, etc. according to particular needs.

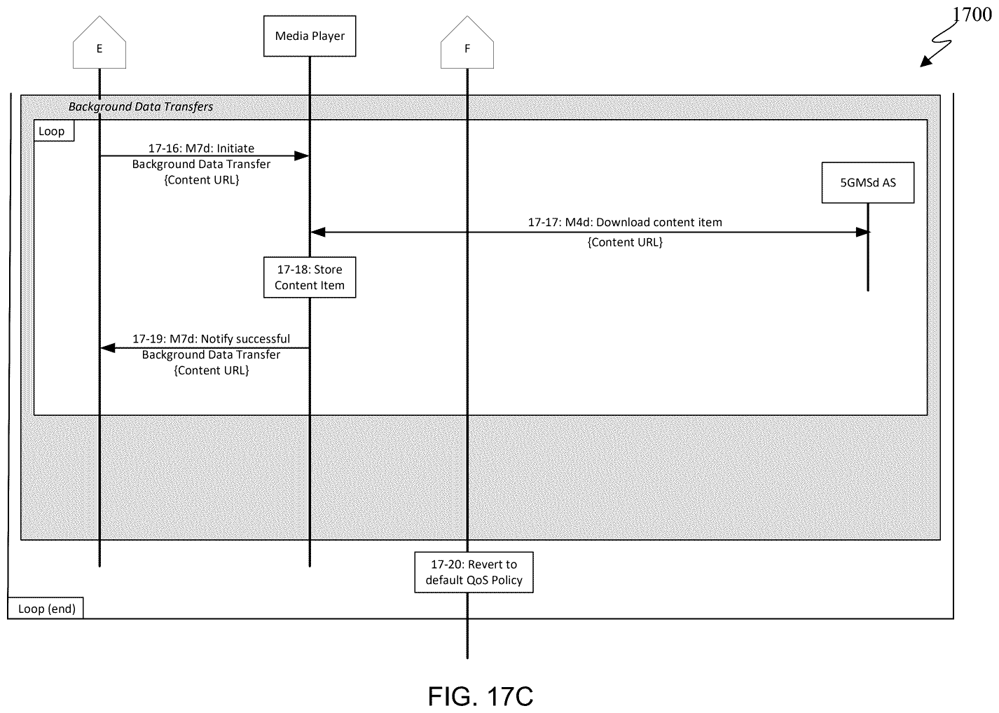

FIGS. 17A-17C illustrate an example procedure 1700 for background data transfer session configuration and establishment according to embodiments of the present disclosure. An embodiment of the procedure illustrated in FIGS. 17A-17C is for illustration only. One or more of the components illustrated in FIGS. 17A-17C may be implemented in specialized circuitry configured to perform the noted functions or one or more of the components may be implemented by one or more processors executing instructions to perform the noted functions. Other embodiments of a procedure for background data transfer session configuration and establishment could be used without departing from the scope of this disclosure.

Using the Background Data Transfer procedure of FIGS. 17A-17C, a network apparatus, for example an application function in the operator network, may provide background data transfer opportunities to the UE. Using the background data transfer feature, clients may download content that could be of use later and not at the present moment. As part of the background data transfer procedure, the external service provider negotiates with the 5GMS system operator about opportunities for clients of the service provider to download content at suitable times, provided necessary resources are available (e.g., download windows, volume etc.). As part of this negotiation, policy information is written to policy functions in the operator network. Later, the service provider provisions the background data transfer feature for a media service at a media application function in the operator network. The application function informs the necessary clients of such a feature. When the clients intend to use the feature, they request establishment of such a policy for background data transfer, and the policy function in the operator network obliges by performing session management procedures to allow for downloading of content using the background data transfer feature.

In the example of FIGS. 17A-17C, procedure 1700 begins at step 17-1. At step 17-1, a 5GMSd application provider creates a policy template with a background data transfer specification. The policy template is transmitted to a 5MGSd application function.

At step 17-2 the 5GMSd creates a background data transfer policy and transmits the policy to a policy control function. In response, the policy control function transmits a background data transfer reference identifier to the 5MGSd application function.

At step 17-3, the 5MGSd application function transmits a confirmation to the 5MGSd application provider that the policy template creation was successful.

At step 17-4, the 5MGSd application function transmits a subscription request for background data transfer warning notifications to the policy control functions.

At step 17-5, a 5MGSd-aware application launches media session handling with a media session handler.

At step 17-6, the media session handler requests service access information from the 5MGSd application function. In response, the 5MGSd application function provides a dynamic policy invocation configuration including background data transfer window specifications to the media session handler.

At step 17-7, the 5MGSd-aware application sends a subscription request for background data transfer opportunity notifications to the media session handler.

At step 17-8, the media session handler notifies the 5MGSd-aware application of a background data transfer opportunity.

At step 17-9, the 5MGSd-aware application requests a background data transfer from the media session handler. The request includes a data volume estimate.

At step 17-10, the media session handler instantiates a policy template according to the data volume estimate with the 5MGSd application function.

At step 17-11, the 5MGSd application function instructs the policy control function to apply a background data transfer policy.

At step 17-12, the 5MGSd application function confirms instantiation of the dynamic policy with the media session handler.

At step 17-13, the media session handler confirms a background data transfer grant with the 5MGSd-aware application. The grant includes a granted time period and a maximum data volume.

At step 17-14, the 5MGSd-aware application sends a subscription request for background data transfer warning notifications to the media session handler.

At step 17-15, the media session handler sends a subscription request for background data transfer warning notifications to the 5MGSd application function.

At step 17-16, the 5MGSd-aware application initiates a background data transfer with a media player.

At step 17-17, the media player downloads a content item from a 5MGSd application server.

At step 17-18, the media player stores the content item.

At step 17-19, the media player notifies the 5MGSd-aware application of a successful background data transfer.

At step 17-20, after all background data transfers have completed, the policy control function reverts to a default quality of service (QoS) policy.

Although FIGS. 17A-17C illustrate one example procedure 1700 for background data transfer session configuration and establishment, various changes may be made to FIGS. 17A-17C. For example, while shown as a series of steps, various steps in FIGS. 17A-17C could overlap, occur in parallel, occur in a different order, occur any number of times, be omitted, or replaced by other steps.

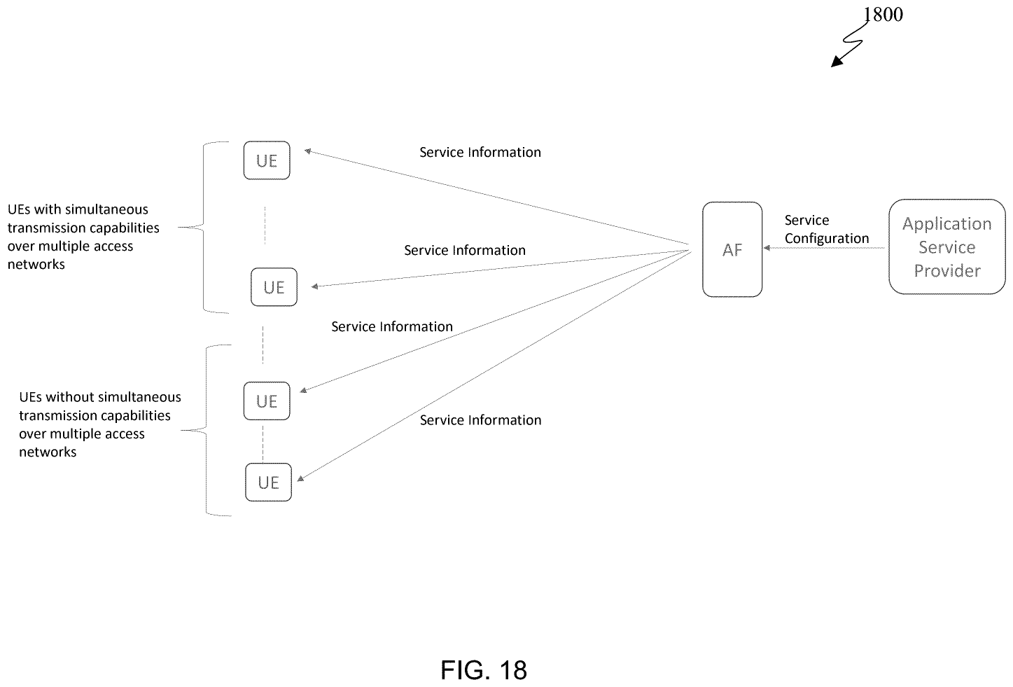

It is possible that one or more UEs may be limited to connection to a single access network at a particular time. For example, the UEs may not have the capability to use multiple access networks simultaneously even if the UEs have the capability to connect to multiple access networks. Therefore, when the service provider sets up a media service and allows/provisions connections to application instances through one or more access networks simultaneously, it is possible that one or more of the UEs are unable to use more than one access network, or one or more of the UEs lack the capability to use multiple accesses simultaneously as shown in FIG. 18.

FIG. 18 illustrates an example 1800 of UEs with different capabilities for simultaneous transmission over multiple access networks according to embodiments of the present disclosure. The embodiment of UEs with different capabilities of FIG. 18 is for illustration only. Different embodiments of UEs with different capabilities for simultaneous transmission over multiple access networks could be used without departing from the scope of this disclosure.

In example 1800 of FIG. 18, the application service provider provisions a service at the AF, and the AF provides the subscribed UEs with the service information. Included in the service information are details about how to access the service over one or more access networks. Some UEs have the capability to receive content of the service over one or more access networks, but some UEs do not have the capability to perform simultaneous transmissions over multiple access networks. This may create QoS/quality of experience (QoE) issues or access issues for the UEs without multiple access capability. The QoS/QoE and access issues may be exacerbated when the service requires that the application flows be distributed and requested along different access paths to utilize the maximum throughput available across all access network paths. In this context, suitable processes can be implemented to support UEs that do not have the capability to perform simultaneous transmission over multiple access networks.

Although FIG. 18 illustrates an example 1800 of UEs with different capabilities for simultaneous transmission over multiple access networks, various changes may be made to FIG. 18. For example, example 1800 could include a different number of UEs, different service configurations, etc. according to particular needs.

As described regarding FIG. 18, there can be two types of UEs with different access capabilities. The terminology in Table 2 may be applied herein when referring to the different types of UEs.

TABLE 2

| Device | |
|---|---|
| Type | Description |
| Type | A UE with capabilities to transmit/receive simultaneously over |
| A UE | multiple access networks at the same time for the same service |
| Type | A UE with no, or minimal, capability to transmit/receive |
| B UE | simultaneously over multiple access networks at the same time |
| | for the same service. These types of UEs may include: |
| | UEs with single access network connections only |
| | UEs with multiple access network connections, but |
| | provisioned by the operator so that only one of the access |
| | networks is to be used for a service |
| | UEs with multiple access network connections, but that |
| | only use one access network for a service due to security |
| | considerations. |

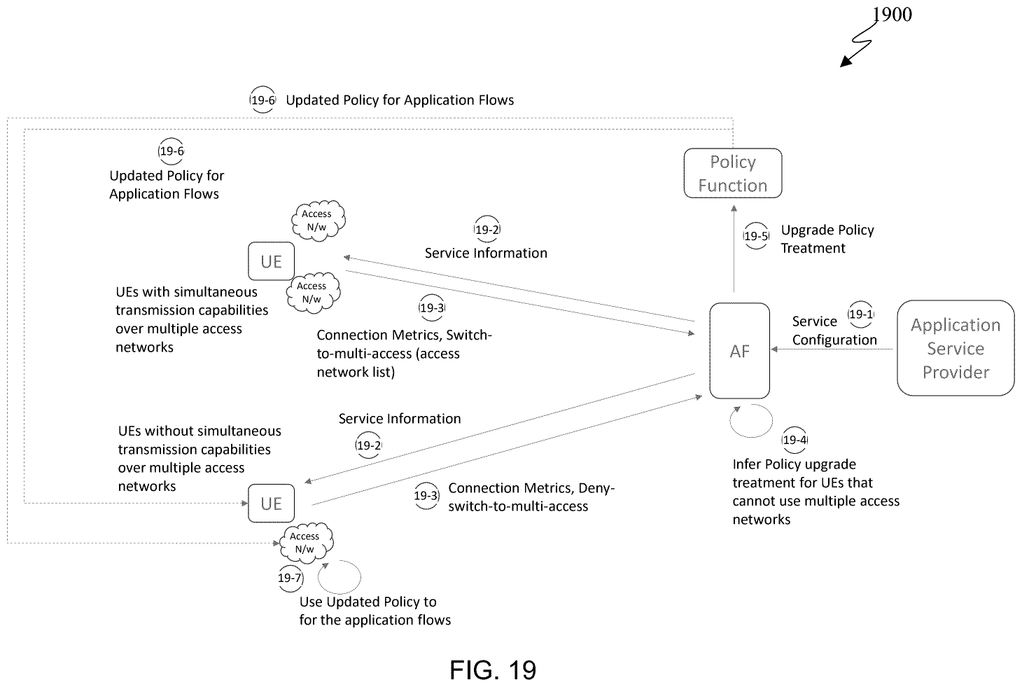

To improve performance for UEs that do not possess the capabilities for simultaneous transmission over multiple access networks, application flows for such UEs may be temporarily upgraded by policy treatments that permit these UEs to retrieve service content in single access that other UEs are able to obtain using multiple access networks. Such application flow upgrades may be facilitated according to the procedure of FIG. 19.

FIG. 19 illustrates an example procedure 1900 to allow a temporary upgrade in policy treatment for application flows of a UE with no capabilities to use multiple access networks simultaneously according to embodiments of the present disclosure. An embodiment of the procedure illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure to allow a temporary upgrade in policy treatment for application flows of a UE with no capabilities to use multiple access networks simultaneously could be used without departing from the scope of this disclosure.

In the example of FIG. 19, procedure 1900 begins at step 19-1. At step 19-1, The service provider provisions, as part of the service provisioning step, that Type B UEs with limited capabilities for using multiple access networks, are allowed to request upgraded policy treatment for their application flows for the service. For example, an M1 service provisioning API may be used to provision such service features at the application function that is responsible for managing the service session in the operator network. An existing service provisioning API may be enhanced to include an additional Boolean field called “allow-limited-UEs-to-request-temporary-upgrade” in the corresponding data model definition. When the application service provider includes this field in the service configuration, the application service provider intends that Type B UEs with limited capabilities for simultaneous transmission over multiple access networks be allowed to request upgraded policy treatment for their application flows.

When the application function receives the above configuration information from the application service provider, the application function takes necessary steps to be reachable through multiple access networks. To facilitate this, the application function may request the operator to setup core network reachability through multiple access networks. The application function also provides the list and type of access networks through which different UEs are to be allowed to connect to the application function. The type of access networks could include 4G LTE, 5G NR, Satellite access, NPN, etc.

At step 19-2, based on service configuration information from the application service provider, the application function builds service access information and forwards the information to the subscribed UEs of the service. The service information may include details such as the following:
Allow-multiple-access: Indicates whether using multiple access networks simultaneously is allowed. If allowed, the application function may indicate different access networks the UE may use to receive the service content. For each of the access networks, the application function may provide additional details such as when the specific access network may be used for transmission/reception of service traffic, the type of access network, the quality parameters applicable for application flows going through the access network (for example, the M5QoSSpecification) etc.
Timing information—Indicates detailed timing information for when the UEs may switch to transmission/reception through multiple access network paths.
Network-switch-notification: Indicates whether the application function may provide a notification to the UE about switching to transmission/reception through multiple access networks. If this is included in the service information, the UE may wait to hear from the application function/network when to switch to transmission/reception through multiple access networks from using a single access network.
UE-switch-notification: Indicates whether the UE is allowed to initiate switching transmission/reception through multiple access networks from a single access network.
Switch-mid-session: Indicates whether the UE is allowed to switch to transmission/reception through multiple access networks midway through the session.

At step 19-3, upon receiving service information from the application function, the UE, at a start time of the service, starts transmission/reception of service content through the UE's preferred access. The UE may start with a single access network to begin with, and may indicate the UE's intent to add more access network paths for transmission/reception of service content (Type A UEs). Along with this intent, the UE may send connection metrics along one or more access network paths through which the UE intends to transmit/receive service content. The connection metrics from the UE may include per-access metrics such as downlink and uplink throughput, uplink and downlink latency, uplink and downlink bandwidth, uplink and downlink packet loss rate, uplink and downlink jitter etc. Optionally, the UE may also send aggregate throughput, bandwidth, latency, jitter, packet loss rate across all access network paths, separately for the downlink and uplink direction. The UE may also provide Average/Min/Max values for each of the above parameters. Type B UEs may indicate an incapability to use multiple access networks simultaneously to the application function, in addition to sending the connection metrics along the single access network path. The connection metrics in this case are the same metrics defined above, but limited to the single access network path that the UE is able to use for transmission/reception of service content.

At step 19-4, when the application function receives information from both types of UEs, the application function may derive updated policy parameters based on the connection metrics from the Type A UEs. Such updated policy parameters may be in the form or Average/Min/Max for each of the connection metrics reported by the Type A UE in the previous step. Based on these derived metrics, the application function may infer additional capacity, or the policy parameters, needed by the Type B UEs with no capability to transmit or receive simultaneously over multiple access networks. For example, if the application function derives the Average throughput based on connection metrics from Type A UEs, and compares them with the corresponding connection metrics received from the Type B UEs, the application may infer the throughput necessary for Type B UEs (e.g., the difference in these throughput values) that has to be provided so these Type B UEs may receive the same content over single access that the Type A UEs are receiving over multiple access networks. The application function may derive the updated policy parameters for each of the parameters described in step 19-3.

At step 19-5, the application function informs the policy function of the network to update the policy treatment, or QoS, for Type B UEs, or their connected access networks, based on the derived policy information in step 19-4.

At step 19-6, the policy function may re-configure the UE end points, or the access network path characteristics attached to the Type B UEs so the Type B UEs now have upgraded policy treatment over the single access network that the Type B UEs use.

At step 19-7, The type B UEs, with no or minimal capability to transmit/receive over multiple access networks simultaneously apply the updated policy parameters and receive the same type and amount of content that Type A UEs transmit/receive over multiple access networks.

Although FIG. 19 illustrates one example procedure 1900 to allow a temporary upgrade in policy treatment for application flows of a UE with no capabilities to use multiple access networks simultaneously, various changes may be made to FIG. 19. For example, while shown as a series of steps, various steps in FIG. 19 could overlap, occur in parallel, occur in a different order, occur any number of times, be omitted, or replaced by other steps.

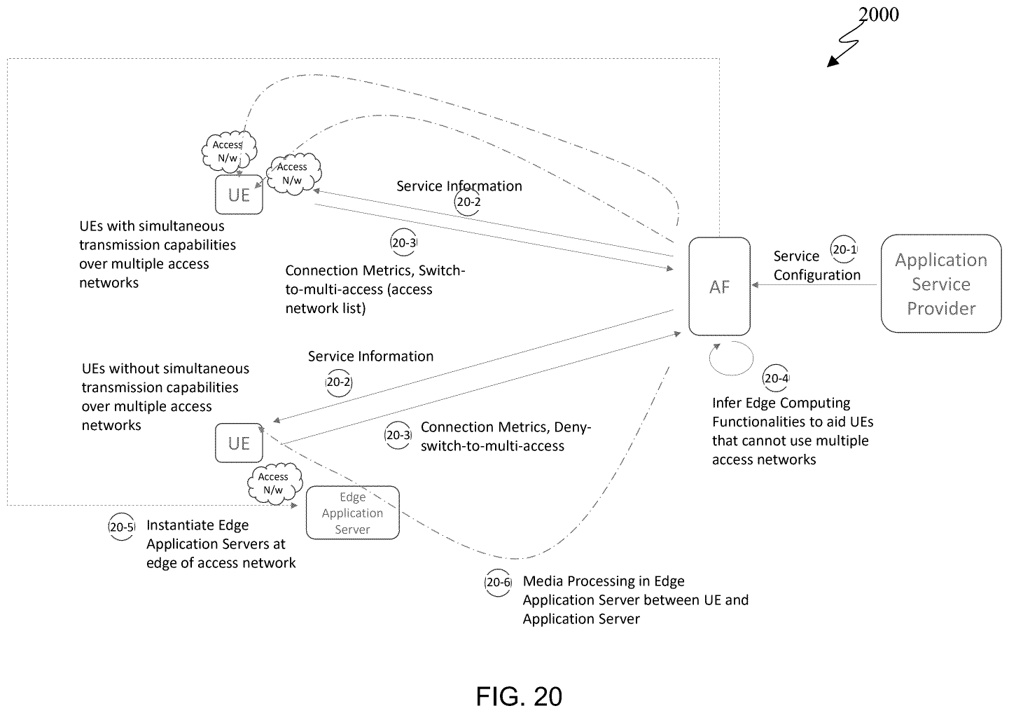

As described herein, to improve performance for UEs that do not possess the capabilities for simultaneous transmission over multiple access networks, application flows for such UEs may be temporarily upgraded by policy treatments that permit these UEs to retrieve service content in single access that other UEs are able to obtain using multiple access networks. Such application flow upgrades may be facilitated based on instantiation of an edge application server according to the procedure of FIG. 20.

FIG. 20 illustrates an example procedure 2000 to instantiate edge application services to aid UEs with no or limited capabilities to use multiple access networks simultaneously according to embodiments of the present disclosure. An embodiment of the procedure illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a procedure to instantiate edge application services to aid UEs with no or limited capabilities to use multiple access networks simultaneously could be used without departing from the scope of this disclosure.

In the example of FIG. 20, procedure 2000 begins at step 20-1. At step 20-1, the service provider provisions, as part of the service provisioning step, that Type B UEs with no or limited capabilities on using multiple access networks simultaneously, are allowed to use the services of edge application servers. For example, an M1 service provisioning API may be used to provision such service features at the application function that is responsible for managing the service session in the operator network. A service provisioning API may be enhanced to include an additional Boolean field called “allow-edge-deployment” in the corresponding data model definition. When the application service provider includes this field in the service configuration, the application service provider intends that Type B UEs be allowed to continue to use the service using an edge application service setup close to the edge of the access network. When the application function receives the above configuration information from the application service provider, the application function takes necessary steps as similar as described regarding procedure 1900.

At step 20-2, based on service configuration information from the application service provider, the application function builds service access information and forwards the information to the subscribed UEs of the service. The service information includes details similar to that of procedure 1900.

At step 20-3, the Type A and Type B UEs may send connection metrics after the start of the service as described in the corresponding step of procedure 1900. In addition, the Type A UEs may indicate their intention to use multiple access networks similar as described regarding procedure 1900. The Type B UEs, similar as described regarding procedure 1900, may indicate their inability to switch to transmitting/receiving over multiple access networks.

At step 20-4, when the application function receives information from both the types of UEs as described in steps 20-1 through 20-3, the application function may infer to operate edge application services closer to the access networks of Type B UEs to aid in their service performance.

At step 20-5, the application function interfaces with the edge computing service provider responsible for access networks connected to Type B UEs and instantiates edge application services/servers in their edge networks. The application function then communicates the updated media service endpoints with the Type B UEs with information of the newly setup edge application services. The application function configures the following at the edge application server:
Network measurements/metrics through the access: The application Function sends end-to-end network measurements/metrics through the access to the edge application server to provide a status of network performance so the edge application server may correctly estimate the transmission/reception parameters with the Type B UEs so that all the UEs (Type A and Type B) are in sync. Alternatively, the application function may send the network status information for the network segment between the remote application server and edge application server. The edge application server is then aware of the network performance parameters in the core network, and therefore can estimate the network parameters between the edge application server and the UE. The network measurements/metrics that the application function sends are that of the same parameters described regarding procedure 1900 for either the end-to-end network path through the access or the segment between the remote applications server/content source and the edge application server.

At step 20-6, the edge application services/servers perform media processing in the edge for content flowing between the remote application server and the UE. The edge application services/servers are responsible for converting multi-access traffic to be delivered over a single access. Such processing may include content stitching, network rendering etc. Post media processing, a limited number of application flows are generated that can be delivered over a single access network to the Type B UEs. For all intents and purposes, the application server is delivering content over multiple access networks to Type A UEs, but for Type B UEs, the same content is sent to the edge application server where it gets processed and converted to a limited number of flows, and delivered over single access to Type B UEs.

Although FIG. 20 illustrates one example procedure 2000 to allow a temporary upgrade in policy treatment for application flows of a UE with no capabilities to use multiple access networks simultaneously, various changes may be made to FIG. 20. For example, while shown as a series of steps, various steps in FIG. 20 could overlap, occur in parallel, occur in a different order, occur any number of times, be omitted, or replaced by other steps.

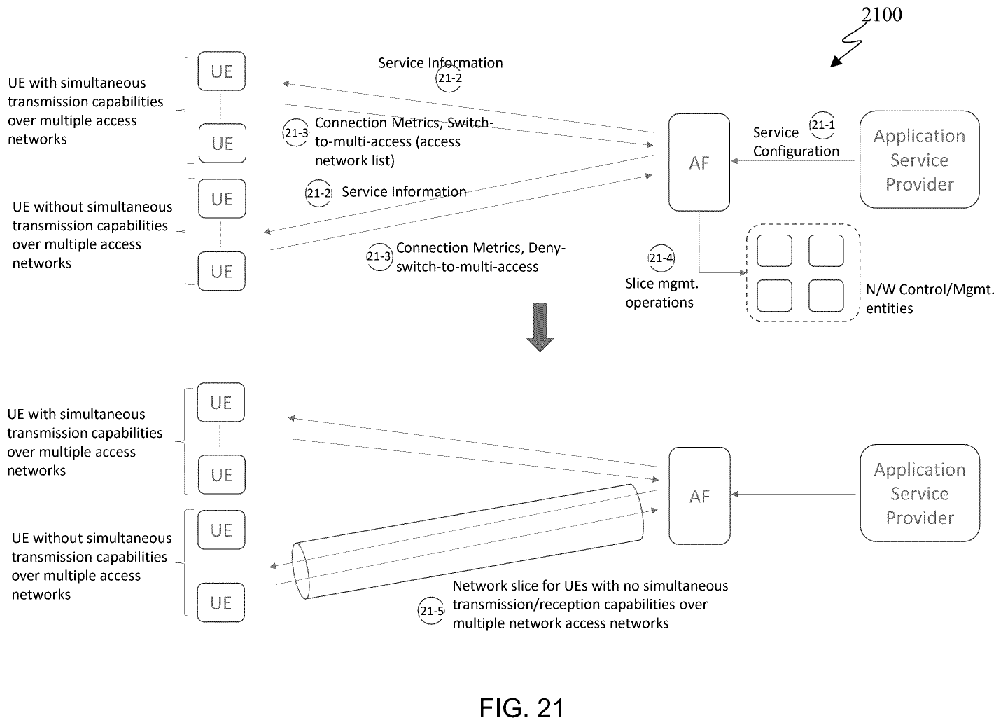

As described herein, to improve performance for UEs that do not possess the capabilities for simultaneous transmission over multiple access networks, application flows for such UEs may be temporarily upgraded by policy treatments that permit these UEs to retrieve service content in single access that other UEs are able to obtain using multiple access networks. Such application flow upgrades may be facilitated based on network slice management operations according to the procedure of FIG. 21.

FIG. 21 illustrates an example procedure 2100 based on network slicing to aid UEs with no or limited capabilities to use multiple access networks simultaneously according to embodiments of the present disclosure. An embodiment of the procedure illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of a procedure based on network slicing to aid UEs with no or limited capabilities to use multiple access networks simultaneously could be used without departing from the scope of this disclosure.

In the example of FIG. 21, procedure 2100 begins at step 21-1. At step 21-1, the service provider provisions, as part of the service provisioning step, that Type B UEs with no or limited capabilities on using multiple access networks simultaneously, may use a separate/dedicated network slice to have similar performance to that of Type A UEs. The provisioning of this information by the application service provider may happen similarly as described regarding procedures 1900 and 2000. A service provisioning API may be enhanced to include an additional Boolean field called “allow-network-slice-ops” in the corresponding data model definition. When the application service provider includes this field in the service configuration, the application service provider intends that application flows of Type B UEs be migrated to a separate/dedicated network slice to have similar performance as that of Type A UEs. When the application function receives the above configuration information from the application service provider, the application function takes necessary steps similar as described regarding procedures 1900 and 2000.

At step 21-2, based on service configuration information from the application service provider, the application function builds service access information and forwards the information to the subscribed UEs of the service. The service information includes details similar to that of procedures 1900 and 2000.

At step 21-3, the Type A and Type B UEs may send connection metrics after the start of the service similar as described in corresponding steps of procedures 1900 and 2000. In addition, the Type A UEs may indicate their intention to use multiple access networks similarly as described regarding procedures 1900 and 2000. The Type B UEs, similar as described regarding procedures 1900 and 2000, may indicate their inability to switch to transmitting/receiving over multiple access networks.

At step 21-4, when the application function receives information from both the types of UEs, the application function may decide to apply network slice operations to aid the UEs with no or limited capability for transmission/reception over multiple access networks. The slice operations could be any of the following:
Create a separate/dedicated network slice: A separate/dedicate network slice may be created for UEs with no or limited capability for transmission/reception over multiple access networks, and all their application flows are moved to the newly created slice. The network slice parameter configuration can be provisioned (for example, with higher values based on estimation of network parameters from Type A UEs as described earlier in the embodiment).
Re-configure network slice parameters: If there is an existing separate/dedicated network slice for Type B UEs, the network slice parameter configuration can be adjusted (for example, allow for upgraded network performance parameters as described in the previous embodiment) so all the application flows in the network slice get a bump up in their policy/QoS/QoE treatment
   The application function may convey one or more of the above slice operations to network control/management entities.

At step 21-5, the network control/management entities perform the requested network slice operations for application flows belonging to Type B UEs so all UEs have the same policy/QoS/QoE behavior.

Although FIG. 21 illustrates one example procedure 2100 based on network slicing to aid UEs with no or limited capabilities to use multiple access networks simultaneously, various changes may be made to FIG. 21. For example, while shown as a series of steps, various steps in FIG. 21 could overlap, occur in parallel, occur in a different order, occur any number of times, be omitted, or replaced by other steps.

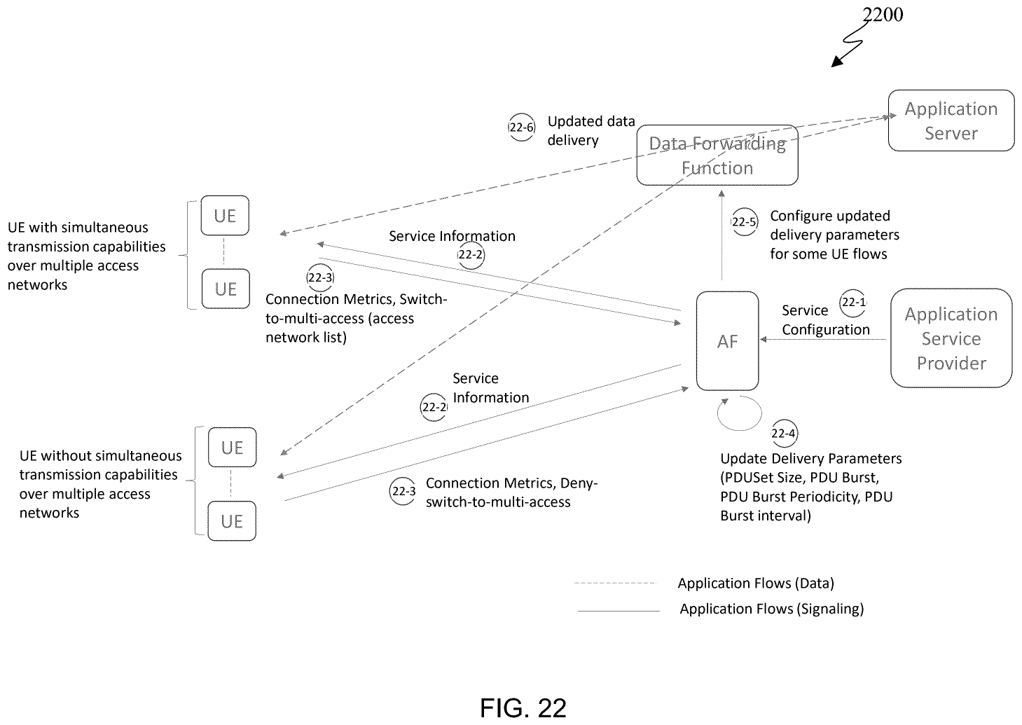

As described herein, to improve performance for UEs that do not possess the capabilities for simultaneous transmission over multiple access networks, application flows for such UEs may be temporarily upgraded by policy treatments that permit these UEs to retrieve service content in single access that other UEs are able to obtain using multiple access networks. Such application flow upgrades may be facilitated based on protocol data unit (PDU) bursts according to the procedure of FIG. 22.

FIG. 22 illustrates an example procedure 2200 based on traffic burst to aid UEs with no or limited capabilities to use multiple access networks simultaneously according to embodiments of the present disclosure. An embodiment of the procedure illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a procedure based on traffic burst to aid UEs with no or limited capabilities to use multiple access networks simultaneously could be used without departing from the scope of this disclosure.

In the example of FIG. 22, procedure 2200 begins at step 22-1. At step 22-1, the service provider provisions, as part of the service provisioning step, that Type B UEs with no or limited capabilities on using multiple access networks simultaneously, may be allowed of different data forwarding treatment for their application flows. The provisioning of this information by the application service provider may happen similarly as described regarding procedures 1900-2100. A service provisioning API may be enhanced to include an additional Boolean field called “allow-data-delivery-features” in the corresponding data model definition. When the application service provider includes this field in the service configuration, the application service provider intends that delivery parameters of application flows of Type A and Type B UEs be adjusted as described regarding procedure 2200. When the application function receives the above configuration information from the application service provider, the application function takes necessary steps similar as described regarding procedures 1900-2100.

At step 22-2, based on service configuration information from the application service provider, the application function builds service access information and forwards the information to the subscribed UEs of the service. The service information includes details similar to that of procedures 1900-2100.

At step 22-3, the Type A and Type B UEs may send connection metrics after the start of the service as described in corresponding steps of procedures 1900-2100. In addition, the Type A UEs may indicate their intention to use multiple access networks similar as described regarding procedures 1900-2100. The Type B UEs, similar as described regarding procedures 1900-2100, may indicate their inability to switch to transmitting/receiving over multiple access networks.

At step 22-4, when the application function receives information from both the types of UEs, the application function may decide to update data delivery parameters to aid the UEs with no or limited capability for transmission/reception over multiple access networks. The application function may also update the data delivery parameters of Type A UEs to match their performance to Type B UEs. The possible adjustments can include any of the following:
The Application PDUs for Type B UEs may be delivered as PDU Sets. The application function may modify the PDU Set size for PDUs destined to Type B UEs so the end-to-end delivery of data PDUs for Type A and Type B UEs match.
The application function may decide to perform PDU bursts for application flows/data of Type B UEs. With this option, Type B UEs receive intermittent bursts of application PDUs while Type A UEs receive only minimal or do not receive any PDU bursts.
The application function may modify the PDU burst periodicity of application flows corresponding to Type B UEs compared to that of Type A UEs (i.e., Type B UEs receive far more PDU bursts compared to Type A UEs). With this option, Type B UEs receive more content on their single access compared to each of the access networks of Type A UEs. However, the aggregate of all access networks for Type A UEs may receive the same number of PDUs as that of the single access of Type B UEs. To perform the match, the application function may keep track of the number of Application PDUs aggregated per access on Type A UEs and Type B UEs. Based on this information, the application function may compute the required PDU burst periodicity so PDUs to Type B UEs match that of Type A UEs.
The application function may modify the PDU burst interval for application flows corresponding to Type B UEs compared to that of Type A UEs. For example, application flows of Type B UEs may have a smaller PDU burst interval compared to Type A UEs. With this option, Type B UEs receive more content on their single access compared to each of the access networks of Type A UEs. However, the aggregate of all access networks for Type A UEs may receive the same number of PDUs as that of the single access of Type B UEs. To perform the match, the application function may keep track of the number of Application PDUs aggregate per access on Type A UEs and Type B UEs. Based on this information, the application function may compute the PDU burst interval so PDUs to Type B UEs match that of Type A UEs
The application function may perform the same action as above for interval packet delivery time of application flows corresponding to Type B UEs so PDUs to Type B UEs match that of Type A UEs

At step 22-5, the application function conveys the updated delivery parameters to the data forwarding function. The conveying of such information may happen through the assistance of other network functions in the operator network.

At step 22-6, the application flows from the application server are delivered based on the updated delivery parameters received from the application function above.

Although FIG. 22 illustrates one example procedure 2200 based on traffic burst to aid UEs with no or limited capabilities to use multiple access networks simultaneously, various changes may be made to FIG. 22. For example, while shown as a series of steps, various steps in FIG. 22 could overlap, occur in parallel, occur in a different order, occur any number of times, be omitted, or replaced by other steps.

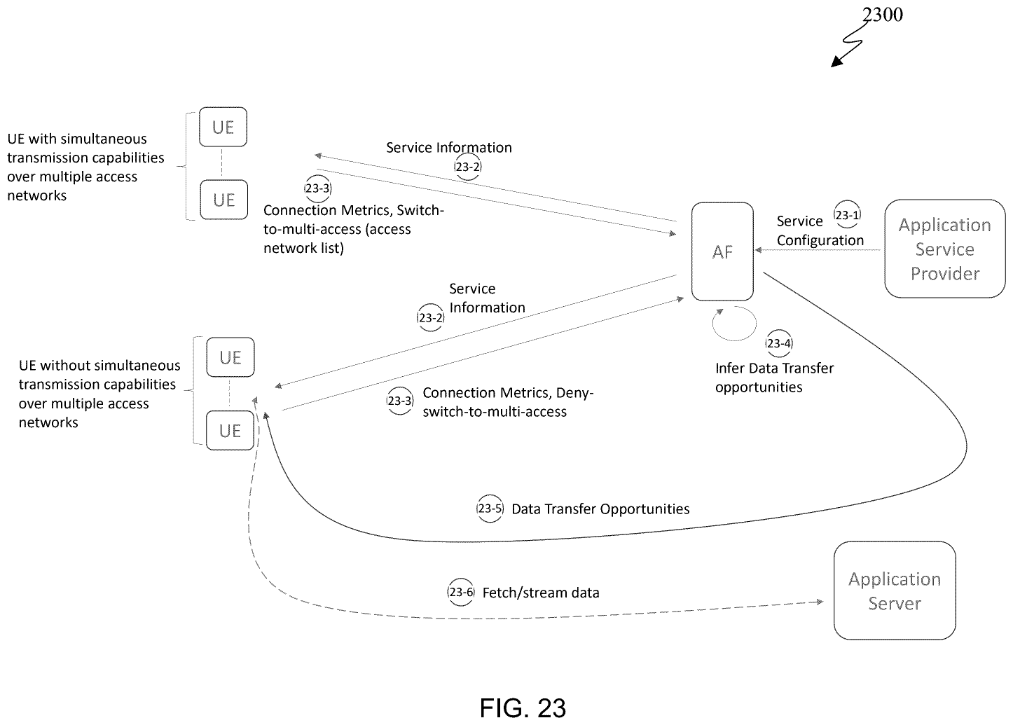

As described herein, to improve performance for UEs that do not possess the capabilities for simultaneous transmission over multiple access networks, application flows for such UEs may be temporarily upgraded by policy treatments that permit these UEs to retrieve service content in single access that other UEs are able to obtain using multiple access networks. Such application flow upgrades may be facilitated using a background data transfer similar as described regarding procedure 1700 of FIG. 17 according to the procedure of FIG. 23.

In some embodiments, using the procedure described regarding FIG. 23 above, the Type B UEs may be provided with opportunities to download/fetch additional content from an application server, sometimes well is advance, so the UEs have the necessary content when the session starts. Alternately, in some embodiments, the application server may send partial data to the Type B UEs during these data transfer opportunities, and the remaining data is sent to the UEs when the UE session starts. The initial partial data sent to the UEs may either be before the session starts, or when the application function gets to know the capability of some UEs with limited capabilities, (for example the Type B UEs). From time to time, the application function observes the data transmitted/received by these Type B UEs and may present opportunities to these UEs to fetch additional content/data.

FIG. 23 illustrates an example procedure 2300 based on data transfer opportunities to aid UEs with no or limited capabilities to use multiple access networks simultaneously according to embodiments of the present disclosure. An embodiment of the procedure illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a procedure based on data transfer opportunities to aid UEs with no or limited capabilities to use multiple access networks simultaneously could be used without departing from the scope of this disclosure.

In the example of FIG. 23, procedure 2300 begins at step 23-1. At step 23-1, The service provider provisions, as part of the service provisioning step, provisions that Type B UEs, with no or limited capabilities on using multiple access networks simultaneously, may be allowed to download/fetch data transfer from an Application Server, for example in an offline mode. The provisioning of this information by the application service provider may happen as described in procedures 1900-2200. A service provisioning API may be enhanced to include an additional Boolean field called “allow-data-transfer-opportunities” in the corresponding data model definition. When the application service provider includes this field in the service configuration, the application service provider intends that Type B UEs may be presented with data transfer opportunities as described regarding procedure 2300. When the application function receives the above configuration information from the application service provider, the application function takes necessary steps similar as described regarding procedures 1900-2200.

At step 23-2, based on service configuration information from the application service provider, the application function builds service access information and forwards the information to the subscribed UEs of the service. The service information includes the above details about potential data transfer opportunities from the application server.

At step 23-3, the Type A and Type B UEs may send connection metrics after the start of the service as described in corresponding step of previous embodiment. In addition, the Type A UEs may indicate their intention to use multiple access networks as described in previous embodiment. The Type B UEs, similar as described regarding procedures 1900-2200, may indicate their inability to switch to transmitting/receiving over multiple access networks.

At step 23-4, when the application function receives information from both the types of UEs, the application function may decide to provide data transfer opportunities to Type B UEs to download/fetch additional content from an application server, in addition to service content currently being received on single access the UE is using.

At step 23-5, the application function informs the UEs about data transfer opportunities. The data transfer opportunities are an enhancement to the background data transfer opportunities of existing wireless networks. The data transfer opportunities described in this disclosure may include these additional details compared to existing wireless networks:
Map of Data Transfer Opportunities: Each element in the map is a <key, value> pair, where ‘key’ represents a time (e.g., wall clock time) and the value represents an object ‘Media Descriptor’. The ‘Media Descriptor’ object is of the following structure:
   Media Type: Type of media to fetch
   URL: Where to fetch media from (e.g., segments)
   Byte Range: Byte Range of media to fetch
   Object collection: Collection of objects to fetch/stream
      The Media Descriptor describes the details of media to be downloaded/fetched/streamed at the time indicated by the key parameter. The application function may include the complete media to be downloaded/fetched/streamed using data transfer opportunities. Alternatively, only partial media may be allowed to be fetched/downloaded/streamed, and the remaining media is delivered to the Type B UEs over the single access they are able to use during the session.

At step 23-6, The Type B UEs use the data transfer opportunities to download/fetch/stream additional content from application server to match the performance of Type A UEs.

Although FIG. 23 illustrates one example procedure 2300 based on data transfer opportunities to aid UEs with no or limited capabilities to use multiple access networks simultaneously, various changes may be made to FIG. 23. For example, while shown as a series of steps, various steps in FIG. 23 could overlap, occur in parallel, occur in a different order, occur any number of times, be omitted, or replaced by other steps.

Procedure 2300 is a procedure for allowing UEs with no or limited capabilities for transmission/reception over multiple networks simultaneously to increase QoS/QoE based on data transfer opportunities. In procedure 2300, the UEs indicate their capabilities and lack thereof to the application function. The application function provides data transfer opportunities to Type B UEs to download/fetch/stream service content from application server so they match the experience of UEs with higher capabilities that can use multiple access networks simultaneously. Alternatively, in some embodiments, the Type B UEs may not need to wait until the service starts to inform the application function of connection metrics and their capabilities to perform multi-access transmission/reception simultaneously. In these embodiments, the UEs indicate their capability to perform simultaneous transmission/reception over multiple access networks well in advance, as early as UE registration to the network. When the application function knows a priori which UEs have the capabilities to perform simultaneous transmission/reception over multiple access networks and which UEs do not, the application function may provide data transfer opportunities, similar as described regarding procedure 2300, even before the service is started (i.e., the application function provides for the ability for the UEs with limited or no capabilities to catch up with the UEs of higher capabilities). The UEs with limited capabilities (e.g., Type B UEs in this disclosure) may pre-download/pre-fetch/pre-stream service content before the service or session starts so these UEs have necessary content to have a similar experience as that of UEs with higher capabilities (e.g., Type A UEs in this disclosure). In these embodiments, the application function may present early data transfer opportunities with precise time windows indicating when and how much to download using the same map of data transfer opportunities described regarding procedure 2300.

As described regarding procedures 1900-2300, the application function is the responsible network apparatus to perform the necessary operations for assisting UEs with limited or no capabilities to perform transmission/reception over multiple access networks simultaneously so the UEs have similar experiences as that of UEs with higher capabilities. Alternatively, in some embodiments, a dedicated network function (e.g., a multi-access network function) can be provisioned by the network operator to assist with these procedures. In this case, instead of the application function, the newly provisioned network function takes the responsibilities of performing all the methods and procedures described regarding procedures 1900-2300.

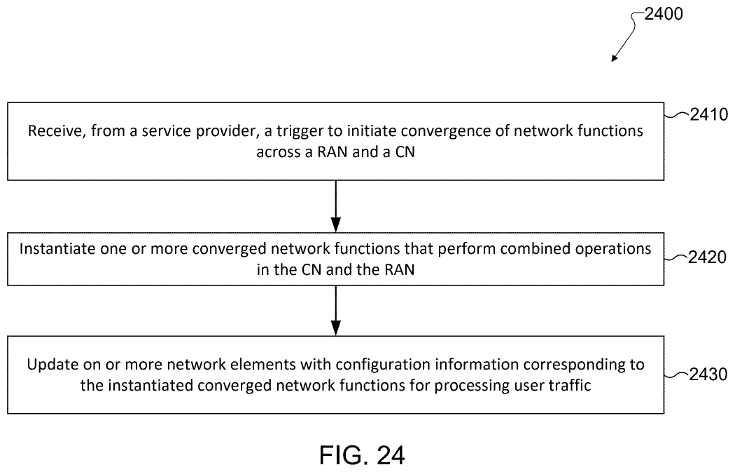

FIG. 24 illustrates an example method 2400 for convergence of network functions for media streaming according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for convergence of network functions for media streaming could be used without departing from the scope of this disclosure.

In the example of FIG. 24, method 2400 begins at step 2410. At step 2410, an apparatus (such as an AF) receives, from a service provider, a trigger to initiate convergence of network functions across a RAN and a CN.

In some embodiments, the trigger may include signaling indicating at least one of (i) enablement of the one or more converged network functions, (ii) a convergence method for the one or more converged network functions, and (iii) one or more relocation conditions for a network function performed by the CN or the RAN.

In some embodiments, the trigger may be based on at least one of (i) a determination that an end-to-end latency across the CN and the RAN exceeds a latency requirement of an application session, and (ii) a determination that a throughput requirement for the application session exceeds an end-to-end throughput capability across the CN and the RAN.

In some embodiments, the trigger may be based on an energy optimization objective associated with one or more network functions, and the one or more converged network functions may be instantiated to optimize energy usage across the CN and the RAN.

At step 2420, based on receiving the trigger, the apparatus instantiates one or more converged network functions that perform combined operations in the CN and the RAN. The combined operations may relate to at least one of policy management, session management, or user plane management.

At step 2430, the apparatus updates one or more network elements with configuration information corresponding to the instantiated converged network functions for processing user session traffic.

In some embodiments, to update the one or more network elements with the configuration information, the apparatus may transmit, to at least one other apparatus operating in one of the CN or the RAN, a policy update including an indication of a convergence method. The convergence method may include at least one of (i) combining at least network function performed by the CN and at least one network function performed by the RAN into a single network function, (ii) co-locating at least network function performed by the CN and at least one network function performed by the RAN in a same NFVI domain, and (iii) relocating at least network function performed by the CN or the RAN from a present NFVI domain of the network function performed by the CN or the RAN to a different NFVI domain.

In some embodiments, the apparatus may further receive connection metric values corresponding to application flows of a service for (i) a first user equipment (UE) that does not have multi-access capability and (ii) a second UE that has multi-access capability. Based on the connection metric values, and a determination that the first UE lacks multi-access capability, and the second UE having multi-access capability, the apparatus may (i) derive a policy to upgrade an application flow corresponding to the first UE, and (ii) upgrade the application flow based on the derived policy. In these embodiments, the combined operations may relate to policy management for the policy to upgrade the application flow.

In some embodiments, to upgrade the application flow, the method further comprises instantiating an EAS at an edge of an access network of the first UE. In these embodiments, instantiation of the one or more converged network functions and the EAS may enable meeting at least one application requirement.

In some embodiments, to upgrade the application flow the apparatus may adjust one or more delivery parameters for the application flow. The one or more delivery parameters may include (i) PDUSet size for a PDU of the application flow, (ii) enablement of a PDU burst for the application flow, (iii) a PDU burst periodicity for the application flow, and (iv) a PDU burst interval for the application flow. In these embodiments, the one or more converged network functions may be instantiated in response to determination of adjustment of the one or more delivery parameters.

In some embodiments, to upgrade the application flow the apparatus may inform the first UE of data transfer opportunities to stream data related to the application flow from an application server. In these embodiments, the one or more converged network functions may be instantiated to facilitate data transfer from the application server to the first UE.

In some embodiments, to upgrade the application flow the apparatus may create a dedicated network slice for the application flow. In these embodiments, the one or more converged network functions may be instantiated in the dedicated network slice.

Although FIG. 24 illustrates one example method 2400 for convergence of network functions for media streaming, various changes may be made to FIG. 24. For example, while shown as a series of steps, various steps in FIG. 24 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An apparatus comprising:
a transceiver configured to receive, from a service provider, a trigger to initiate convergence of network functions across a radio access network (RAN) and a core network (CN); and
a processor operably coupled to the transceiver, the processor configured to:
based on receiving the trigger, instantiate one or more converged network functions that perform combined operations in the CN and the RAN, wherein the combined operations relate to at least one of policy management, session management, or user plane management; and
update one or more network elements with configuration information corresponding to the instantiated converged network functions for processing user session traffic.

2. The apparatus of claim 1, wherein to update the one or more network elements with the configuration information, the processor is further configured to cause the transceiver to transmit, to at least one other apparatus operating in one of the CN or the RAN, a policy update including an indication of a convergence method, the convergence method including at least one of:
combining at least network function performed by the CN and at least one network function performed by the RAN into a single network function;
co-locating at least network function performed by the CN and at least one network function performed by the RAN in a same network function virtualization infrastructure (NFVI) domain; and
relocating at least network function performed by the CN or the RAN from a present NFVI domain of the network function performed by the CN or the RAN to a different NFVI domain.

3. The apparatus of claim 1, wherein the trigger includes signaling indicating at least one of:
enablement of the one or more converged network functions;
a convergence method for the one or more converged network functions; and
one or more relocation conditions for a network function performed by the CN or the RAN.

4. The apparatus of claim 1, wherein the trigger is based on at least one of:
a determination that an end-to-end latency across the CN and the RAN exceeds a latency requirement of an application session; and
a determination that a throughput requirement for the application session exceeds an end-to-end throughput capability across the CN and the RAN.

5. The apparatus of claim 1, wherein:
the trigger is based on an energy optimization objective associated with one or more network functions; and
the one or more converged network functions are instantiated to optimize energy usage across the CN and the RAN.

6. The apparatus of claim 1, wherein:
the transceiver is further configured to:
receive connection metric values corresponding to application flows of a service for (i) a first user equipment (UE) that does not have multi-access capability and (ii) a second UE that has multi-access capability;
the processor is further configured to, based on the connection metric values, and a determination that the first UE lacks multi-access capability, and the second UE having multi-access capability:
derive a policy to upgrade an application flow corresponding to the first UE; and
upgrade the application flow based on the derived policy; and
the derived policy enables a quality of service for the first UE that is comparable to that experienced by the second UE.

7. The apparatus of claim 6, wherein:
to upgrade the application flow the processor is further configured to instantiate an edge application server (EAS) at an edge of an access network of the first UE, and
instantiation of the one or more converged network functions and the EAS enables meeting at least one application requirement.

8. The apparatus of claim 6, wherein:
to upgrade the application flow the processor is further configured to adjust one or more delivery parameters for the application flow, the one or more delivery parameters including:
protocol data unit (PDU) set (PDU Set) size for a PDU of the application flow;
enablement of a PDU burst for the application flow;
a PDU burst periodicity for the application flow; and
a PDU burst interval for the application flow; and
the one or more converged network functions are instantiated in response to determination of adjustment of the one or more delivery parameters.

9. The apparatus of claim 6, wherein:
to upgrade the application flow the processor is further configured to inform the first UE of data transfer opportunities to stream data related to the application flow from an application server, and
the one or more converged network functions are instantiated to facilitate data transfer from the application server to the first UE.

10. The apparatus of claim 6, wherein:
to upgrade the application flow the processor is further configured to create a dedicated network slice for the application flow, and
the one or more converged network functions are instantiated in the dedicated network slice.

11. A method of operating an apparatus, the method comprising:
receiving, from a service provider, a trigger to initiate convergence of network functions across a radio access network (RAN) and a core network (CN); and
based on receiving the trigger, instantiating one or more converged network functions that perform combined operations in the CN and the RAN, wherein the combined operations relate to at least one of policy management, session management, or user plane management; and
updating one or more network elements with configuration information corresponding to the instantiated converged network functions for processing user session traffic.

12. The method of claim 11, wherein to update the one or more network elements with the configuration information, the method further comprises transmitting, to at least one other apparatus operating in one of the CN or the RAN, a policy update including an indication of a convergence method, the convergence method including at least one of:
combining at least network function performed by the CN and at least one network function performed by the RAN into a single network function;
co-locating at least network function performed by the CN and at least one network function performed by the RAN in a same network function virtualization infrastructure (NFVI) domain; and
relocating at least network function performed by the CN or the RAN from a present NFVI domain of the network function performed by the CN or the RAN to a different NFVI domain.

13. The method of claim 11, wherein the trigger includes signaling indicating at least one of:
enablement of the one or more converged network functions;
a convergence method for the one or more converged network functions; and
one or more relocation conditions for a network function performed by the CN or the RAN.

14. The method of claim 11, wherein the trigger is based on at least one of:
a determination that an end-to-end latency across the CN and the RAN exceeds a latency requirement of an application session; and
a determination that a throughput requirement for the application session exceeds an end-to-end throughput capability across the CN and the RAN.

15. The method of claim 11, wherein:
the trigger is based on an energy optimization objective associated with one or more network functions; and
the one or more converged network functions are instantiated to optimize energy usage across the CN and the RAN.

16. The method of claim 11, further comprising:
receiving connection metric values corresponding to application flows of a service for (i) a first user equipment (UE) that does not have multi-access capability and (ii) a second UE that has multi-access capability; and
based on the connection metric values, and a determination that the first UE lacks multi-access capability, and the second UE having multi-access capability:
deriving a policy to upgrade an application flow corresponding to the first UE; and
upgrading the application flow based on the derived policy,
wherein the derived policy enables a quality of service for the first UE that is comparable to that experienced by the second UE.

17. The method of claim 16, wherein:
to upgrade the application flow the method further comprises instantiating an edge application server (EAS) at an edge of an access network of the first UE; and
instantiation of the one or more converged network functions and the EAS enables meeting at least one application requirement.

18. The method of claim 16, wherein:
to upgrade the application flow the method further comprises adjusting one or more delivery parameters for the application flow, the one or more delivery parameters including:
protocol data unit (PDU) set (PDU Set) size for a PDU of the application flow;
enablement of a PDU burst for the application flow;
a PDU burst periodicity for the application flow; and
a PDU burst interval for the application flow; and
the one or more converged network functions are instantiated in response to determination of adjustment of the one or more delivery parameters.

19. The method of claim 16, wherein:
to upgrade the application flow the method further comprises informing the first UE of data transfer opportunities to stream data related to the application flow from an application server, and
the one or more converged network functions are instantiated to facilitate data transfer from the application server to the first UE.

20. The method of claim 16, wherein:
to upgrade the application flow the method further comprising creating a dedicated network slice for the application flow, and
the one or more converged network functions are instantiated in the dedicated network slice.
